(19) United States
(12) Patent Application Publication
(10) Pub. No.: US 2025/0177951 A1
(43) Pub. Date: Jun. 5, 2025

(54) METAL-ORGANIC FRAMEWORK MATERIALS FOR CARBON DIOXIDE CAPTURE UNDER HIGH HUMIDITY

(71) Applicant: Northwestern University, Evanston, IL (US)

(72) Inventors: Xiaoliang Wang, Wilmette, IL (US); Omar K. Farha, Glenview, IL (US); Randall Q. Snurr, Evanston, IL (US); Maytham Alzayer, Qatif (SA)

(21) Appl. No.: 18/963,881

(22) Filed: Nov. 29, 2024

Related U.S. Application Data
(60) Provisional application No. 63/605,248, filed on Dec. 1, 2023.

(51) Int. Cl. B01J 20/22; B01D 53/04; B01J 20/30; C07F 3/06

(52) U.S. Cl. CPC B01J 20/226; B01D 53/04; B01J 20/3078; B01J 20/3085; C07F 3/06; B01D 2253/204; B01D 2257/504; B01D 2258/0283

(57) ABSTRACT

A material is provided comprising a Zn-(methyltriazolate)-(oxalate) metal-organic framework (MOF) having a chemical formula of Zn(3-methyl-1H-1,2,4-triazolate)(oxalate)_{0.5} (Zn(mtz)(ox)_{0.5}) and comprising oxalate groups forming oxalate layers and (mtz)Zn₂(mtz) groups forming (mtz)Zn₂(mtz) layers. In some embodiments, oxalate groups of adjacent oxalate layers are parallel, wherein each methyl group of each (mtz)Zn₂(mtz) group is oriented in opposing directions, and wherein adjacent methyl groups of adjacent (mtz)Zn₂(mtz) groups and on a same side of planes defined by the oxalate groups are oriented in opposing directions. In other embodiments, oxalate groups of adjacent oxalate layers are non-parallel, and wherein each methyl group of each (mtz)Zn₂(mtz) group is oriented in the same direction. Methods of using the materials to capture CO₂ are also provided. Methods for synthesizing Zn-(methyltriazolate)-(oxalate) MOFs are also provided.

### CROSS-REFERENCE TO RELATED APPLICATIONS

The present application claims priority to U.S. provisional patent application No. 63/605,248 that was filed Dec. 1, 2023, the entire contents of which are incorporated herein by reference.

### REFERENCE TO GOVERNMENT RIGHTS

This invention was made with government support under grant number CBET2119433 awarded by the National Science Foundation and grant number DE-SC0022332 awarded by the Department of Energy. The government has certain rights in the invention.

### BACKGROUND

Due to the ability of carbon dioxide (CO₂) to trap heat as a greenhouse gas, the accumulation of anthropogenic CO₂ in the Earth's atmosphere from fossil fuel combustion is influencing the climate and contributing to the increasing frequency of natural disasters. As a result, the global community is seeking to reduce atmospheric carbon and achieve carbon neutrality in the next few decades. While renewable energy sources have shown promise to limit CO₂ emissions, carbon capture has emerged as a critical and complementary strategy for mitigating carbon emissions and more rapidly addressing the wide-ranging impacts of climate change. Currently, multiple carbon capture technologies are available for capturing CO₂ from industrial processes, including pre-combustion capture, oxy-fuel combustion capture, and post-combustion capture, and each option exhibits distinct advantages and limitations. Among these approaches, post-combustion CO₂ capture methods have garnered the most attention, primarily due to their adaptability, as these capture devices can be retrofitted into existing facilities.

### SUMMARY

Provided are methods of synthesizing metal-organic framework (MOF) materials. The MOF materials and methods of using the MOF materials to capture CO₂, including under high humidity conditions are also provided. The present disclosure is illustrated by reference to an Example, below, which describes the synthesis of Zn-based MOFs denoted NU-220, CALF-20M-w-LT, CALF-20M-w-HT, and CALF-20M-e, that feature hydrophobic methyl-triazolate linkers. The Example further demonstrates that the MOFs improve CO₂ uptake in the presence of water as compared to a Zn-based MOF that does not include the hydrophobic methyl-triazolate linker, i.e., CALF-20. Notably, both CALF-20M-w-HT and CALF-20M-c retain over 20% of their initial CO₂ capture efficiency at 70% to 80% relative humidity (RH)—a threshold at which CALF-20 shows negligible CO₂ uptake. Grand canonical Monte Carlo (GCMC) simulations reveal that the methyl group provided by the methyl-triazolate linker hinders water network formation in the pores of CALF-20M-w-LT and CALF-20M-e and enhances their CO₂ selectivity over N₂ in the presence of high moisture content. Moreover, calculated radial distribution functions indicate that introducing the methyl group into the triazolate linker increases the distance between water molecules and Zn coordination bonds, offering insights into the origin of the enhanced moisture stability observed for CALF-20M-w-LT and CALF-20M-e relative to CALF-20. These results show that the disclosed design strategy has afforded more robust sorbents that meet the challenge of effectively capturing CO₂ in practical industrial applications.

In one aspect, a material is provided comprising a Zn-(methyltriazolate)-(oxalate) metal-organic framework (MOF) having a chemical formula of Zn(3-methyl-1H-1,2,4-triazolate)(oxalate)_{0.5} (Zn(mtz)(ox)_{0.5}) and comprising oxalate groups forming oxalate layers and (mtz)Zn₂(mtz) groups forming (mtz)Zn₂(mtz) layers. In some embodiments, oxalate groups of adjacent oxalate layers are parallel, wherein each methyl group of each (mtz)Zn₂(mtz) group is oriented in opposing directions, and wherein adjacent methyl groups of adjacent (mtz)Zn₂(mtz) groups and on a same side of planes defined by the oxalate groups are oriented in opposing directions. In other embodiments, oxalate groups of adjacent oxalate layers are non-parallel, and wherein each methyl group of each (mtz)Zn₂(mtz) group is oriented in the same direction

In another aspect, a method for synthesizing a Zn-(methyltriazolate)-(oxalate) MOF is provided, the method comprising exposing a solution comprising zinc oxalate, 3-methyl-1H-1,2,4-triazole, and a solvent under conditions to induce crystallization of a Zn-(methyltriazolate)-(oxalate) MOF having a chemical formula of Zn(mtz)(ox)_{0.5} from the zinc oxalate and the 3-methyl-1H-1,2,4-triazole.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings. Color versions of the figures can be found in Wang, Xiaoliang, et al. “Tailoring Hydrophobicity and Pore Environment in Physisorbents for Improved Carbon Dioxide Capture under High Humidity.” Journal of the American Chemical Society 146.6(2024): 3943-3954, the disclosure of which is incorporated herein for the purpose of providing color figures.

FIG. 1A depicts two views of the structure of NU-220 and a view of the zinc coordination. Next are depicted views of the structure (top) of CALF-20 (FIG. 1B) CALF-20M-w-LT (FIG. 1C) and CALF-20M-c (FIG. 1D) including the structure of zinc-triazolate layer, orientation of each layer pillared by oxalate (middle) and corresponding single pore channel dimensions (bottom). (Color scheme: Carbon: grey; Nitrogen: blue; Oxygen: red; Zinc: cyan; Hydrogen: pink).

FIGS. 2A-2F show sorption isotherms and PXRD for CALF-20, NU-220, CALF-20M-w-HT and CALF-20M-c: (FIGS. 2A and 2B) CO₂ isotherms at 298 K and (FIG. 2D) water isotherms at 298 K. (FIG. 2C) Heat of adsorption of CO₂ of all sorbents obtained from CO₂ isotherms at 273 K, 298 K and 313 K. (FIG. 2D, pressure increment mode) PXRD of simulated and as-synthesized sorbents. (FIG. 2F) PXRD profiles relevant to phase transition after boiling in different solvents (water, methanol and ethanol) at 453 K for 24 hours. FIG. 2G show PXRD for CALF-20M-c (top), CALF-20M-w-HT (middle), and CALF-20M-w-LT (bottom).

FIG. 3A shows CO₂ isotherms at 298 K and FIG. 3B shows PXRD of CALF-20M-w (HT in FIG. 3A and LT in FIG. 3B) before and after aging at 343 K, 80% RH for 7 and 15 days. Silicon was mixed with the sorbent to quantitatively analyze variations in intensity from characteristic peaks. FIG. 3C shows crystallinity changes after SAA experiments at 343 K, 80% RH for 2, 7, 15 days compared to the pristine samples. FIG. 3D shows VT-PXRD for CALF-20M-w-LT from 298 to 623 K. The temperature ramp was set to 5 K min-1, holding for 5 min at each set point.

FIGS. 4A-4F show results from GCMC simulations. (FIG. 4A) Radial distribution functions (RDF) between the Zn—N bond and the water molecules in four sorbents. (FIG. 4B) Comparison of experimental and simulated CO₂ isotherms at 298 K in CALF-20M-w (HT experimental and LT simulated). Configurations of water molecules at 95% RH from single-component simulations were obtained (data not shown). (FIGS. 4C and 4D) Percentage of water molecules with one or two H-bonds with other water molecules and one H-bond with the framework in CALF-20 and CALF-20M-w-LT. (FIGS. 4E and 4F) Simulated competitive isotherms for CO₂, water and N₂ at 313 K for CALF-20 and CALF-20M-w-LT.

FIG. 5A shows CO₂ and N₂ isotherms in NU-220, CALF-20M-w-HT, and CALF-20M-c at 298 K. FIG. 5B shows experimental breakthrough curves of NU-220, CALF-20M-w-HT and CALF-20M-e with the binary mixture of CO₂/N₂(15/85, v/v). The flow rate was set at 5 cc/min, and the experiments were conducted at 1 bar and 298 K. Solid circles represent CO₂ and hollow circles represent N₂. FIGS. 5C and 5D show CO₂ captured amount and efficiency under different humidities for CALF-20, NU-220, CALF-20M-w-HT and CALF-20M-c. Data from an in-situ gas loading PXRD experiment (λ0.2116 Å) on (FIG. 5E) NU-220 and (FIG. 5F) CALF-20M-w-HT. The sample was loaded under dry conditions with dry helium (dHe), dry CO₂ (dCO₂), and humid conditions (100% RH) with helium (wHe) and humid CO₂ (wCO₂).

FIG. 6 is a schematic depicting the enhancement of CO₂ capture under high relative humidity with CALF-20M-w-LT and CALF-20M-e via modification of CALF-20 with a hydrophobic methyl group.

FIG. 7 shows a water isotherms at 298 K, including a Type I isotherm (top) and when S-shaped, kinked isotherm that is not associated with the IUPAC water isotherm types but suggests a phase transition. To the right is a schematic showing the coordination pattern changes between CALF-20M-w-HT (phase I structure) and CALF-20M-w-LT (phase IV structure) induced via heat and moisture.

FIGS. 8A and 8B show water (FIG. 8A, dose increment mode) and CO₂ (FIG. 8B) isotherms at 298 K after high-temperature (HT) and low-temperature (LT) activation of CALF-20M-w. A portion of the schematic of FIG. 7 is shown to the right of FIG. 8B.

FIG. 9 shows breakthrough curves for CO₂ and N₂(15/85, v/v) at 298 K and 1 bar for CALF-20M-w-HT and CALF-20M-w-LT, with a flow rate of 5 sccm.

FIGS. 10A and 10B show adsorption-desorption cycling for (FIG. 10A) CALF-20M-w-HT and (FIG. 10B) CALF-20M-w-LT: desorption—N₂ at 180° C. (20 min) CALF-20M-w-HT and 100° C. (20 min) for CALF-20M-w-LT and adsorption—15% CO₂ in N₂ at 25° C. (30 min).

FIG. 11A shows CO₂ isotherms and FIG. 11B shows water isotherms at 298 K after introducing specific amounts of mtz in CALF-20 to improve its CO₂ capture performance competing to moisture.

FIG. 12A is a schematic showing the coordination pattern in CALF-20M-w-LT.

FIG. 12B is a schematic showing the coordination pattern in CALF-20M-w-HT. FIG. 12C is a schematic showing the coordination pattern in CALF-20M-c.

### DETAILED DESCRIPTION

Metal-organic frameworks (MOFs) are hybrid, crystalline, porous materials made from metal-ligand networks that include inorganic nodes, composed of metal ions or metal ion clusters, connected by organic linkers. The present disclosure provides Zn-(methyl triazolate)-(oxalate) MOFs in which the inorganic nodes are composed of zinc ions connected by methyl triazolate linkers and oxalate linkers.

The present MOFs may be synthesized by exposing a solution of zinc oxalate, 3-methyl-1H-1,2,4-triazole, and a solvent under conditions to induce crystallization of the MOF from the zinc oxalate and the 3-methyl-1H-1,2,4-triazole. The method may further comprise an activation step which may be carried out by heating the MOF at an activation temperature for a period of time. As described in detail in the Example, below, it has been found that the solvent being used determines the physical characteristics of the resulting MOF, and therefore, its properties. For a given solvent, the activation temperature being used can also determine the physical characteristics of the resulting MOF and its properties. Regarding the solvent, either methanol, water, or ethanol may be used. The selected solvent is characterized as “neat” or “pure,” by which it is meant that it is not a mixture of different solvent components and is generally free of other components other than the selected solvent. Otherwise, the conditions being used to induce crystallization refer to those generally used in solvothermal/hydrothermal synthesis, include heating at an elevated temperature for a period of time under elevated pressure. Illustrative conditions are provided in the Example, below. Regarding the activation temperature, the particular value can depend upon the selected solvent. Illustrative activation temperatures, including when using certain solvents, are provided in the Example, below. However, in embodiments, the temperature is 70° C. or greater, 120° C. or greater, 125° C. or greater, 130° C. or greater, or 135° C. or greater. This includes any range between these values. In embodiments, the solvent is pure ethanol and the activation temperature is 70° C. or greater. In embodiments, the solvent is pure water and the temperature is 120° C. or greater.

Although each solvent described above provides a Zn-(methyltriazolate)-(oxalate) MOF having a chemical formula Zn(mtz)(ox)_{0.5} (mtz=3-methyl-1,2,4-triazolate and ox=oxalate), the different solvents provide physically distinct MOFs. As noted above, for a given solvent, the activation temperature being used can also provide physically distinct MOFs. For example, the use of pure methanol as the solvent provides a NU-220 MOF while the use of pure ethanol as the solvent provides a CALF-20M-e MOF. The use of pure water as the solvent and an activation temperature below 100° C. provides a CALF-20M-w-LT MOF (LT=low temperature) while the use of pure water as the solvent and an activation temperature above 120° C. provides a CALF-20M-w-HT MOF (HT=high temperature). The unique physical characteristics of each of these MOFs is further described below. These unique physical characteristics distinguish the various MOFs from one another and further distinguish the MOFs from a comparative MOF synthesized using zinc oxalate and a different organic linker, 1H-1,2,4-triazole (no methyl group).

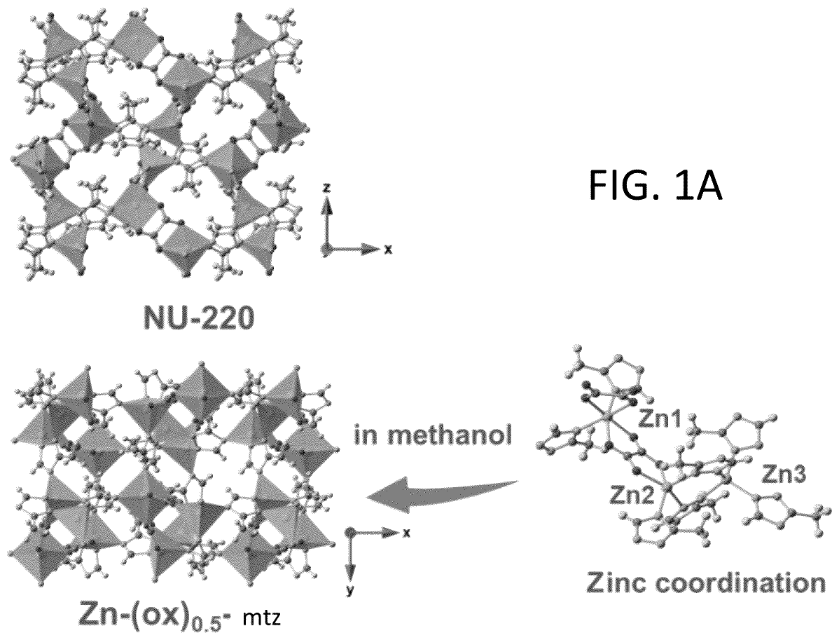

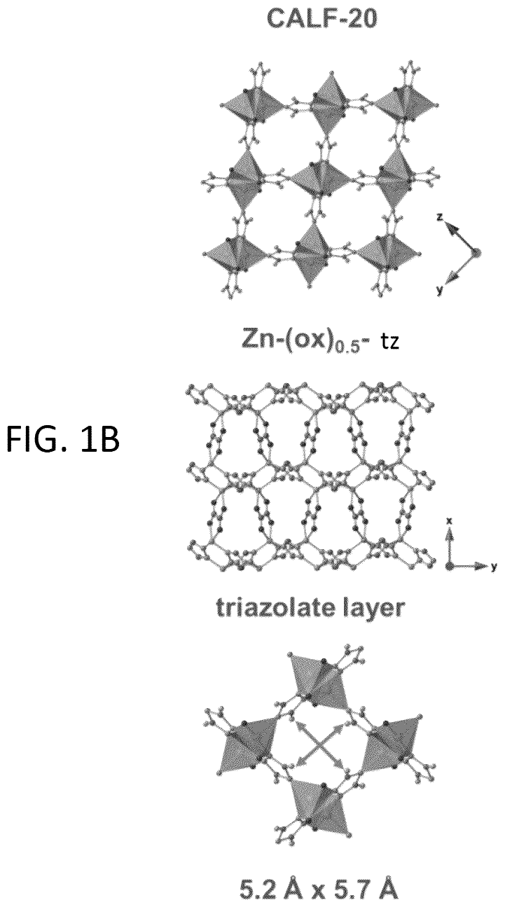

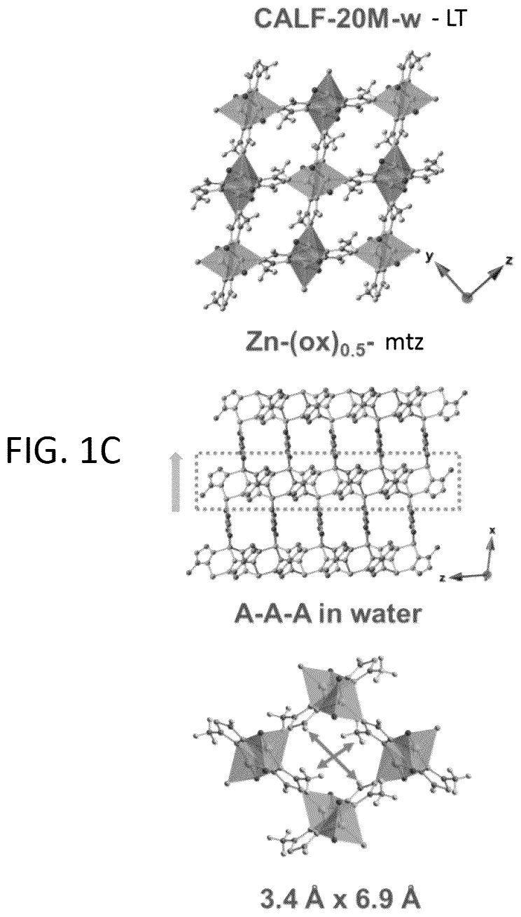

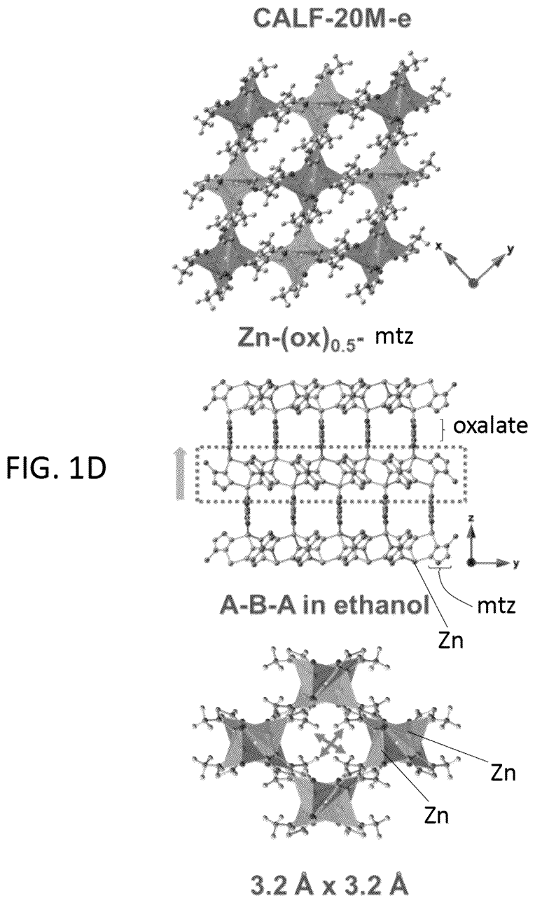

The structure of NU-220 MOF, synthesized using pure methanol as the solvent, is shown in FIG. 1A. This MOF crystallizes in the tetragonal space group P4₃2₁2 and includes three types of zinc ions: hexa-coordinated zinc connected to two mtz linkers and two cis-oxalate linkers; penta-coordinated zinc connected to three mtz linkers and one bridged oxalate linker; and tetra-coordinated zinc connected to four mtz linkers.

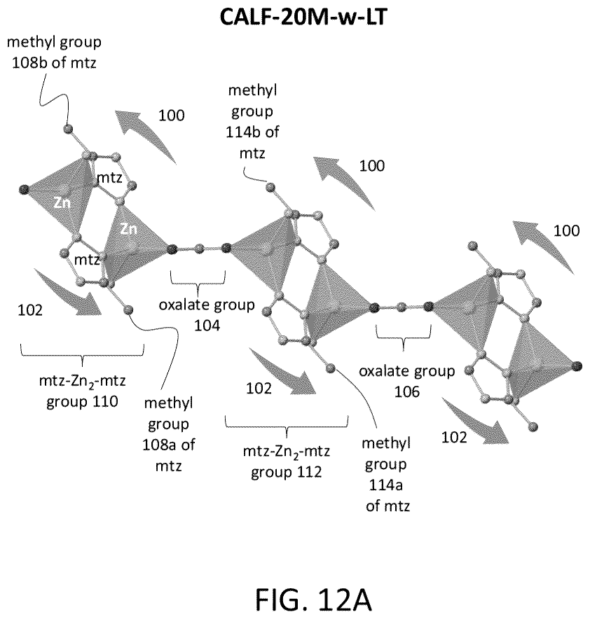

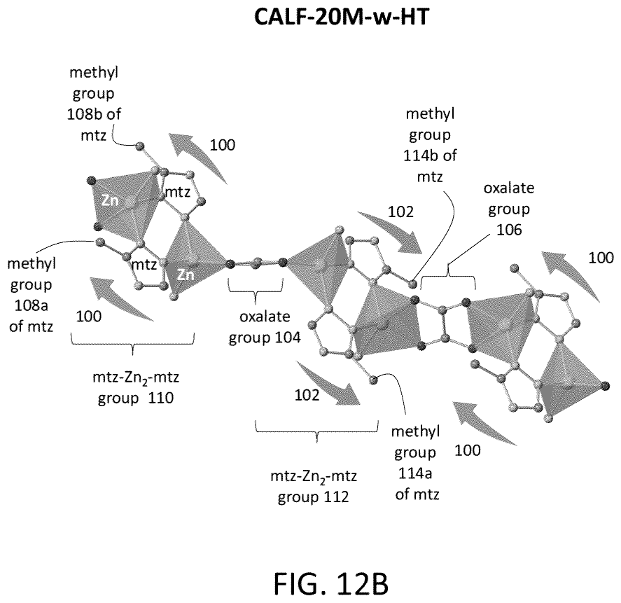

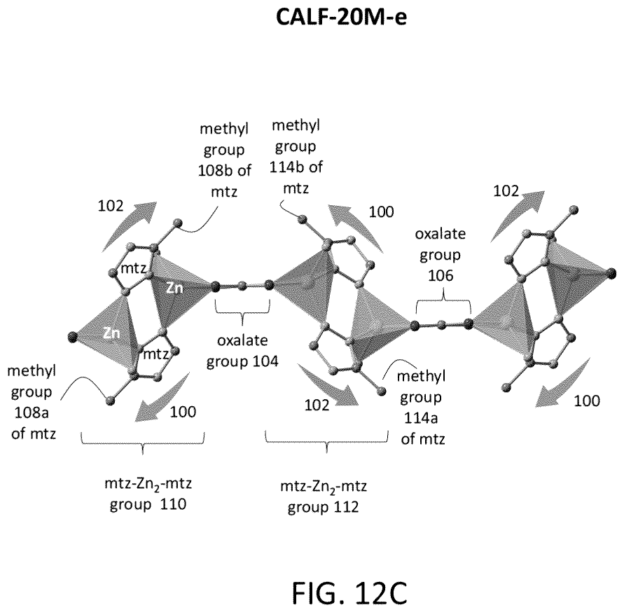

The structure of CALF-20M-w-LT MOF, synthesized using pure water as the solvent and an activation temperature below 100° C. is shown in the top image of FIG. 1C. This MOF crystallizes in the monoclinic P2₁/c space group and has penta-coordinated zinc connected to three mtz linkers and an oxalate linker. The orientation of the mtz linkers is further described below with reference to FIG. 12A. The bottom image of FIG. 1C shows the average dimensions of the channel-like pores in this MOF. Notably, the methyl groups of the mtz linkers line the pores of the MOF, rendering them hydrophobic.

Using pure water as the solvent but a higher activation temperature provides CALF-20M-w-HT MOF. This MOF crystallizes in the monoclinic P2₁/c space group and has penta-coordinated zinc connected to three mtz linkers and an oxalate linker. The orientation of the mtz linkers is further described below with reference to FIG. 12B. The methyl groups of the mtz linkers also line the channel-like pores of the MOF, rendering them hydrophobic.

The structure of CALF-20M-e MOF, synthesized using pure ethanol as the solvent is shown in the top image of FIG. 1D. This MOF crystallizes in the orthorhombic Pbcn space group and has penta-coordinated zinc connected to three mtz linkers and an oxalate linker. The orientation of the mtz linkers is further described below with reference to FIG. 12C. The bottom image of FIG. 1D shows the average dimensions of the channel-like pores in this MOF. The methyl groups of the mtz linkers also line the pores of the MOF, rendering them hydrophobic.

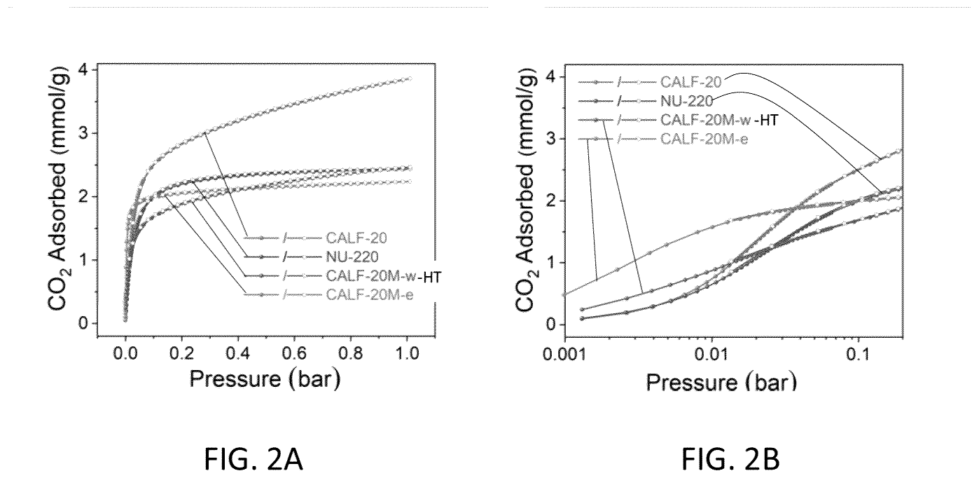

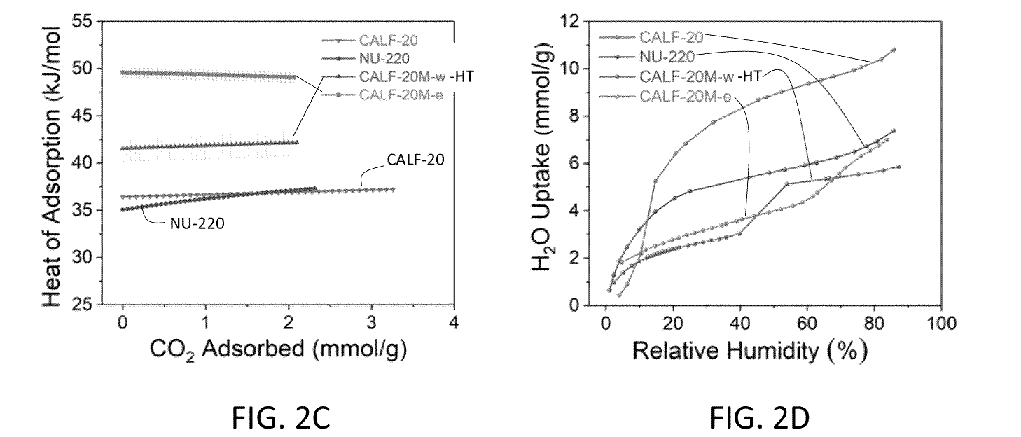

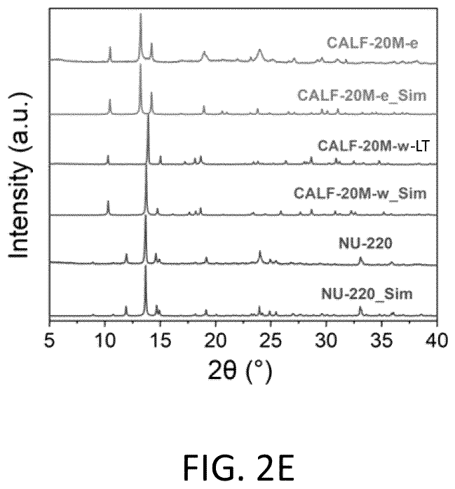

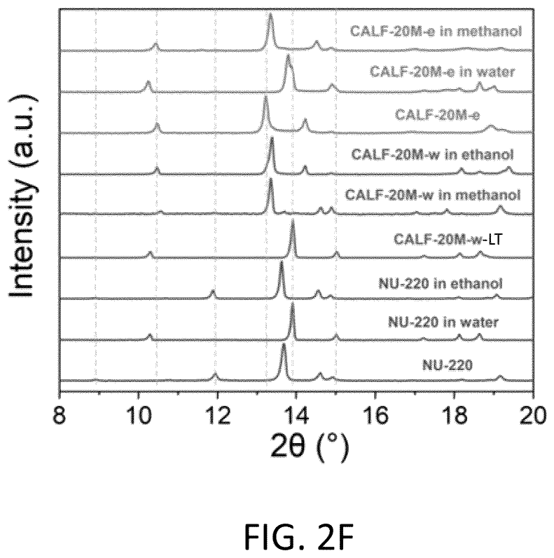

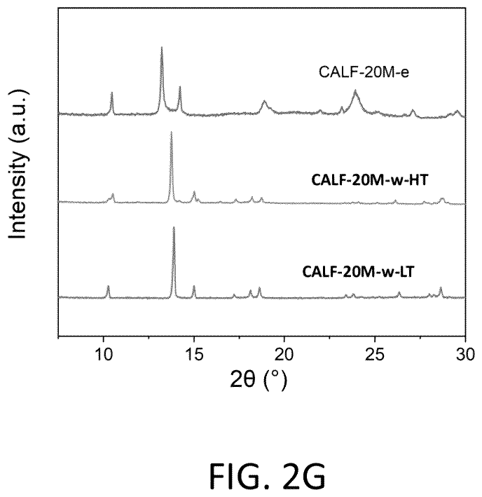

Powder X-ray diffraction (PXRD) spectra may also be used to characterize the MOFs, including to distinguish the MOFs from one another. This is shown by comparing the PXRD spectra (measured at room temperature) for various MOFs as shown in FIG. 2G (see also FIG. 2E). PXRD spectra may be measured using the techniques described in the Example, below. The CALF-20M-e MOF may be characterized by a room temperature PXRD spectrum that comprises three single peaks (i.e., singlets) at 10.48°, 13.22°, and 14.22°. The CALF-20M-w-HT MOF may be characterized by a room temperature PXRD spectrum that comprises a set of two peaks (i.e., a doublet) at 10.28° and 10.52°, another doublet at 15.02° and 15.21°, and a singlet at 13.77°. CALF-20M-w-LT may be characterized by a room temperature PXRD spectrum that comprises three singlets at 10.27°, 13.88°, and 15.00°.

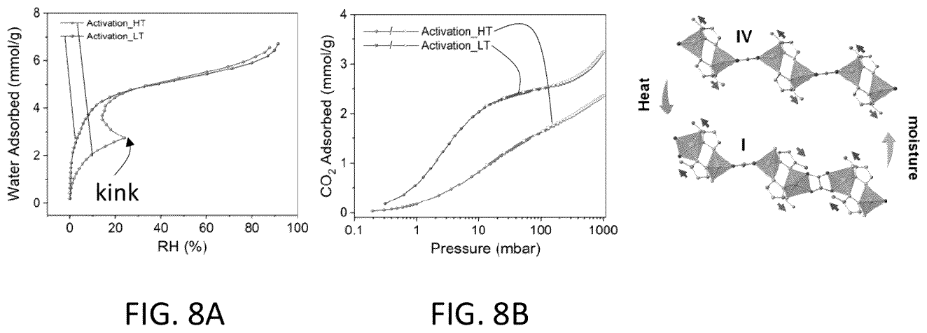

Water isotherms may also be used to characterize the MOFs, including to distinguish the MOFs from one another. This is shown by comparing the water isotherms (measured at room temperature) for various MOFs as shown in FIG. 2D and FIG. 8A. Water isotherms may be measured using the techniques described in the Example, below. This includes measurements in pressure increment mode (FIG. 2D) or dose increment mode (FIG. 8A). For example, CALF-20, NU-220, and CALF-20M-w-LT may each be characterized as exhibiting a Type I room temperature water isotherm. The CALF-20M-e MOF may be characterized as exhibiting a Type II room temperature water isotherm. The terms “Type I” and “Type II” refer to the standard, known IUPAC definitions. As shown in FIG. 8A, CALF-20M-w-HT exhibits room temperature water isotherm that has an unexpected and unique kinked, S-shape.

The present MOFs may be characterized by linker orientation, which is demonstrated by reference to FIGS. 12A-12C. Linker orientation may be determined using the single-crystal X-ray diffraction as described in the Example, below. FIG. 12A shows a portion of the crystal structure of CALF-20M-w-LT, displaying unidirectional alignment among triazolate layers (Zn-mtz). Oxalate groups of adjacent oxalate layers are parallel with one another, e.g., oxalate group 104 is parallel with oxalate group 106. Planes defined by mtz-Zn₂-mtz groups form an angle of 63.2° with planes defined by adjacent oxalate groups of adjacent oxalate layers, e.g., mtz-Zn₂-mtz group 110 forms an angle of 63.2° with adjacent oxalate group 104. The two methyl groups of each mtz-Zn₂-mtz group are oriented in opposing directions to one another, e.g., methyl group 108b on mtz-Zn₂-mtz group 110 is oriented in a first direction 100 and methyl group 108a on mtz-Zn₂-mtz group 110 is oriented in a second, opposing direction 102. Adjacent methyl groups of adjacent mtz-Zn₂-mtz groups and on the same side of planes defined by oxalate groups (e.g., oxalate group 104 and adjacent oxalate group 106) are oriented in the same direction, e.g., methyl group 108b is oriented in the first direction 100 and methyl group 114b is oriented in the first direction 100. Similarly, methyl group 108a is oriented in the second, opposing direction 102 and methyl group 114a is oriented in the second, opposing direction 102. This gives rise to a unidirectional methyl group orientation on each side of the planes defined by oxalate groups.

FIG. 12B shows a portion of the crystal structure of CALF-20M-w-HT. By contrast to FIG. 12A, CALF-20M-w-HT features non-parallel oxalate layers, e.g., oxalate group 104 is non-parallel with oxalate group 106. Planes defined by adjacent oxalate groups of adjacent oxalate layers form an angle of 50.64° with one another, e.g., oxalate group 104 forms an angle of 50.64° with adjacent oxalate group 106. The two methyl groups of each mtz-Zn₂-mtz group are oriented in the same direction, e.g., methyl groups 108a and 108b on mtz-Zn₂-mtz group 110 are both oriented in the first direction 100. Adjacent methyl groups of adjacent mtz-Zn₂-mtz groups are oriented in opposing directions, e.g., methyl group 108b is oriented in the first direction 100 and methyl group 114b is oriented in the second opposing direction 102. Similarly, methyl group 108a is oriented in the first direction 100 and methyl group 114a is oriented in the second, opposing direction 102. This gives rise to an alternating methyl group orientation. Planes defined by mtz-Zn₂-mtz groups form angles of 62.75° and 87.06° with planes defined by adjacent oxalate groups of adjacent oxalate layers, respectively, e.g., mtz-Zn₂-mtz group 112 forms an angle of 62.75° with adjacent oxalate group 104 and an angle of 87.06° with adjacent oxalate group 106.

FIG. 12C shows a portion of the crystal structure of CALF-20M-c. CALF-20M-e features parallel oxalate layers, e.g., oxalate group 104 is parallel with oxalate group 106. Planes defined by mtz-Zn₂-mtz groups form an angle of 63.2° with planes defined by adjacent oxalate groups of adjacent oxalate layers, e.g., mtz-Zn₂-mtz group 110 forms an angle of 63.2° with adjacent oxalate group 104. The two methyl groups of each mtz-Zn₂-mtz group are oriented in opposing directions to one another, e.g., methyl group 108a on mtz-Zn₂-mtz group 110 is oriented in the first direction 100 and methyl group 108b on mtz-Zn₂-mtz group 110 is oriented in the second, opposing direction 102. Adjacent methyl groups of adjacent mtz-Zn₂-mtz groups and on the same side of planes defined by oxalate groups (e.g., oxalate group 104 and adjacent oxalate group 106) are oriented in opposing directions, e.g., methyl group 108a is oriented in the first direction 100 and methyl group 114a is oriented in the second, opposing direction 102. Similarly, methyl group 108b is oriented in the second, opposing direction 102 and methyl group 114b is oriented in the first direction 100. This gives rise to an alternating methyl group orientation on each side of the planes defined by oxalate groups.

As noted above, the present Zn-(methyltriazolate)-(oxalate) MOFs are physically distinct from one another. They are also physically distinct from CALF-20, the comparative MOF synthesized using zinc oxalate and a different organic linker, 1H-1,2,4-triazole (no methyl group). The structure of the CALF-20 MOF is shown in FIG. 1B. Physical distinctions include having different space groups, zinc coordination, linker orientation, pore dimensions, PXRD spectra, water isotherms and combinations thereof. Other differences, e.g., bond angles and bond lengths are described in the Example, below.

The physical differences of the present MOFs result in functional differences which are described in detail in the Example, below. However, these functional differences include different CO₂ sorption behavior as demonstrated in FIGS. 2A and 2B, showing CO₂ sorption isotherms at 298 K and under dry conditions (relative humidity is 0%) for the NU-220, CALF-20M-w-HT, and CALF-20M-e MOFs and the comparative CALF-20 MOF. As described in the Example, below, CALF-20M-e exhibits the greatest calculated heat of adsorption (Qₛₜ) among the MOFs and thus, the strongest interactions with CO₂. Notably, the CO₂ sorption of CALF-20M-e and CALF-20M-w-HT is higher than the other MOFs at low CO₂ pressures. This includes CALF-20M-c and CALF-20M-w-HT exhibiting a CO₂ uptake of at least 0.25 mmol/g (or at least 0.35 mmol/g or at least 0.5 mmol/g) over a range of from 0.001 to 0.01 bar CO₂ (as measured at room temperature and under dry conditions).

Functional differences also include different H₂O sorption behavior as demonstrated in FIG. 2D, showing H₂O sorption isotherms at 298 K for the NU-220, CALF-20M-w-HT, and CALF-20M-e MOFs and the comparative CALF-20 MOF. As described in the Example, below, the increased water uptake exhibited by the Zn-(methyltriazolate)-(oxalate) MOFs at very low relative humidity is surprising given the hydrophobicity of the pore in these MOFs due to the methyl groups. Still, it is notable that at higher relative humidities, the water uptake of CALF-20M-w-HT and CALF-20M-e is less than the other MOFs. This includes CALF-20M-e and CALF-20M-w-HT exhibiting a water uptake of less than 5 mmol/g (or 4.5 mmol/g or 4 mmol/g) up to 50% RH (as measured at room temperature).

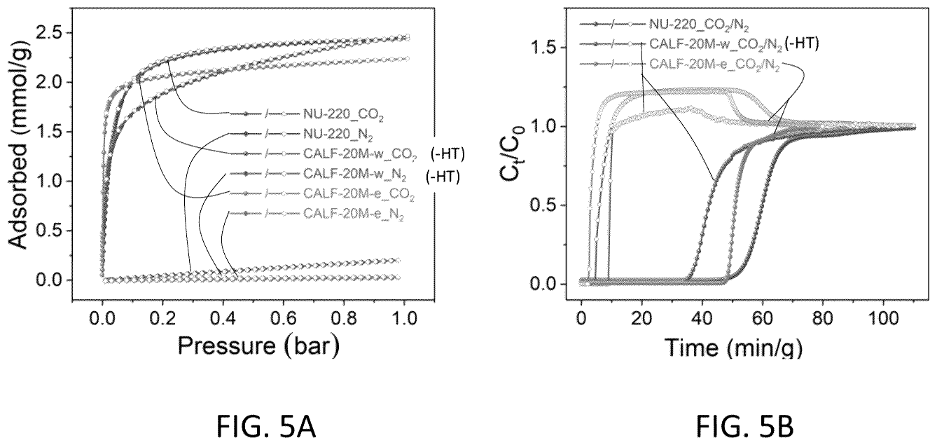

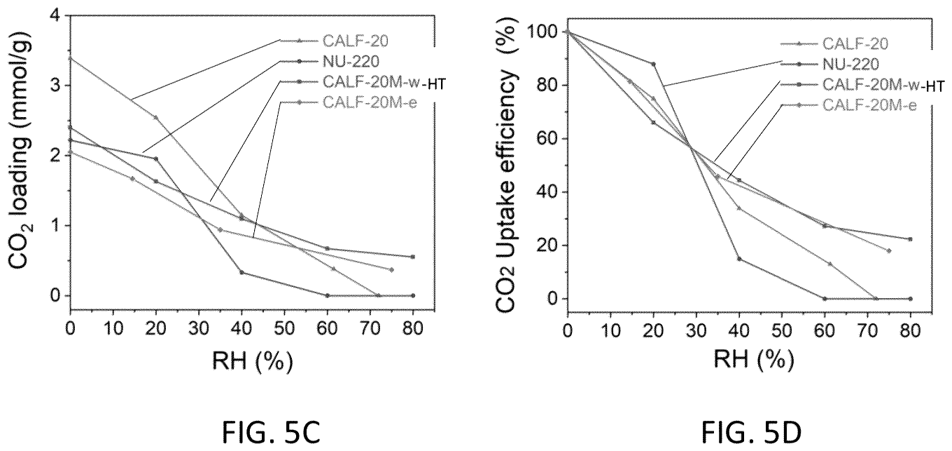

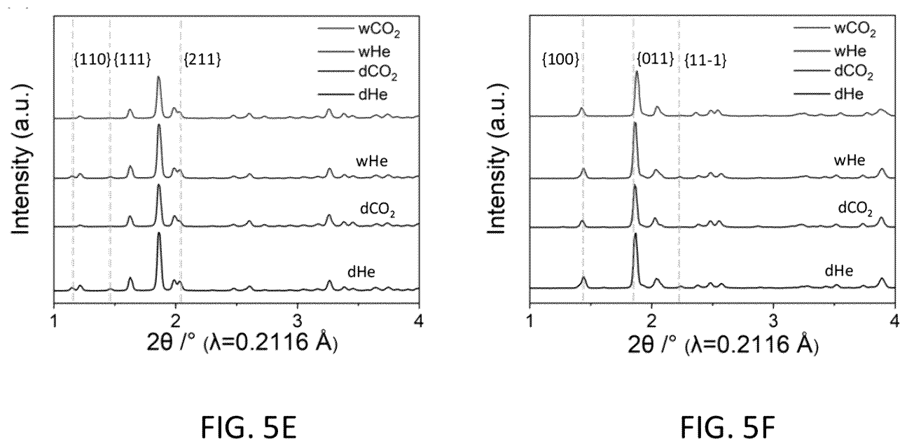

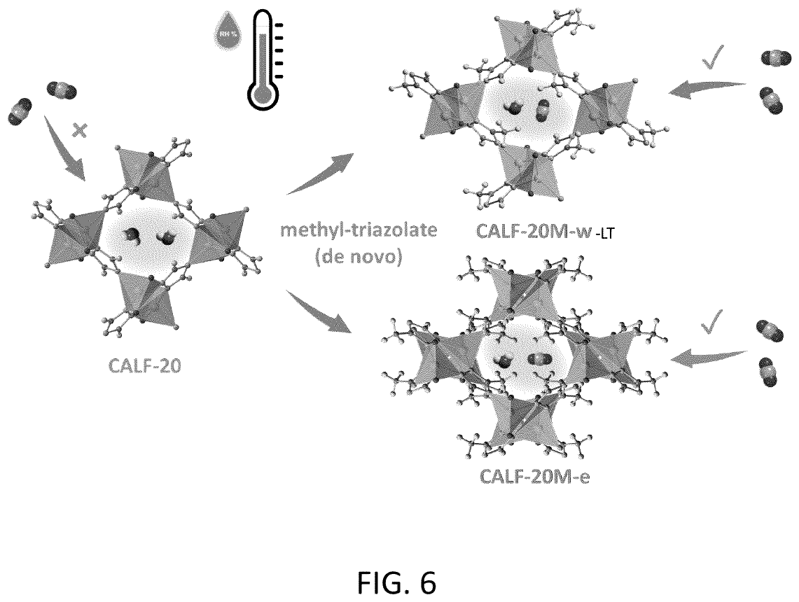

Functional differences further include different CO₂ loading and CO₂ uptake efficiencies as a function of relative humidity (RH). This is demonstrated in FIG. 5C (CO₂ loading) and FIG. 5D (CO₂ uptake efficiency) for the NU-220, CALF-20M-w-HT, and CALF-20M-e MOFs and the comparative CALF-20 MOF. Notably, while the CO₂ loading and CO₂ uptake efficiency of the comparative CALF-20 MOF drops quickly and is about zero at 70% RH, both CALF-20M-w-HT and CALF-20M-e retain over 20% of their initial CO₂ capture efficiency at 70% to 80% RH. This includes CALF-20M-e and CALF-20M-w-HT exhibiting a CO₂ loading of at least 0.5 mmol/g (or at least 0.6 mmol/g) from 65% to 80% RH (as measured at room temperature and a CO₂ partial pressure of 0.15 bar). This includes CALF-20M-c and CALF-20M-w-HT exhibiting a CO₂ uptake efficiency of at least 20% (or 25% or 30%) from 65% to 80% RH (as measured at room temperature and a CO₂ partial pressure of 0.15 bar).

Thus, the present MOFs may be used in a method for capturing CO₂. In such a method, any of the disclosed Zn-(methyltriazolate)-(oxalate) MOFs are exposed to an atmosphere comprising CO₂. As described above, the CO₂ in the atmosphere is adsorbed by the MOF and thereby, removed therefrom. The atmosphere may comprise other components, e.g., N₂, water, etc., such that the method separates the CO₂ from the other components in the gas mixture. In embodiments, the atmosphere is a flue gas. In embodiments, the atmosphere (or flue gas) is characterized by a relative humidity (RH) of at least 50%, at least 55%, at least 60%, at least 65%, at least 70%, at least 75%, at least 80%, or a range of between any of these values. In embodiments, the atmosphere (or flue gas) is characterized by a CO₂ partial pressure in a range of from 0.10 bar to 0.20 bar and a total pressure of 1 bar. In an additional step, the adsorbed CO₂ can then be removed from the MOF.

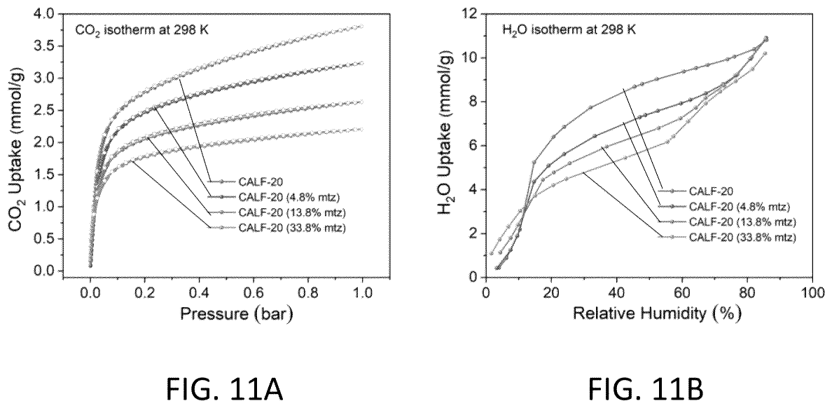

The present MOF synthesis methods may make use of 3-methyl-1H-1,2,4-triazole and different organic linker, 1H-1,2,4-triazole (no methyl group), wherein the two types of linkers are present in different amounts. In embodiments, both linkers are used and the 3-methyl-1H-1,2,4-triazole is used in an amount of less than 15 weight % (amount of 3-methyl-1H-1,2,4-triazole/(amount of 3-methyl-1H-1,2,4-triazole and 1H-1,2,4-triazole)*100). This includes less than 10 weight %, less than 5 weight %, and a range between any of these values. This may be used to tune CO₂ and H₂O sorption characteristics, (See FIGS. 11A and 11B.)

The term “NU-220” and the like refers to a Zn-(methyltriazolate)-(oxalate) MOF having a chemical formula of Zn(mtz)(ox)_{0.5}, synthesized as described herein using pure methanol as the solvent, and having the physical and functional characteristics as described herein.

The term “CALF-20M-w-LT” and the like refers to a Zn-(methyltriazolate)-(oxalate) MOF having a chemical formula of Zn(mtz)(ox)_{0.5}, synthesized as described herein using pure water as the solvent and an activation temperature below 100° C., and having the physical and functional characteristics as described herein.

The term “CALF-20M-w-HT” and the like refers to a Zn-(methyltriazolate)-(oxalate) MOF having a chemical formula of Zn(mtz)(ox)_{0.5}, synthesized as described herein using pure water as the solvent and an activation temperature above 120° C., and having the physical and functional characteristics as described herein

The term “CALF-20M-e” and the like refers to a Zn-(methyltriazolate)-(oxalate) MOF having a chemical formula of Zn(mtz)(ox)_{0.5}, synthesized as described herein using pure ethanol as the solvent, and having the physical and functional characteristics as described herein.

The present MOFs, materials (e.g., sorbents) comprising the MOFs, and systems comprising the sorbents, e.g., systems configured to capture CO₂, are also encompassed by the present disclosure.

### EXAMPLE

This Example describes a strategy to increase the water stability and CO₂ adsorption properties of a MOF material involving the incorporation of hydrophobic groups, such as a methyl (—CH₃) group, into the triazolate linker of CALF-20. The methyl group incorporation specifically involved replacing the hydrogen atom on the 3-position of the 1,2,4-triazole (tz) ring of the organic linker of CALF-20.

Using this strategy, distinct MOFs were synthesized using the 3-methyl-1H-1,2,4-triazole (mtz) linker and zinc oxalate (ZnOx), and it was found that the solvent and reaction conditions determined the structure of the MOF product. Methanol-assisted synthesis resulted in a MOF, denoted as NU-220. Reactions performed in ethanol afforded CALF-20M-c. Reactions performed in water and lower activation temperatures resulted in CALF-20M-w-LT (LT=low temperature) while higher activation temperatures resulted in CALF-20M-w-HT (HT=high temperature). Herein, CALF-20M-w may be used to refer to the use of water as a solvent without regard to activation temperature and thus, may encompass both of CALF-20M-w-LT and CALF-20M-w-HT.

Notably, the MOF materials exhibited between 1.81 and 2.13 mmol g⁻¹ CO₂ uptake at 0.15 bar (i.e., the typical CO₂ partial pressure in flue gas), which corresponded to 69-78% of the capacity of CALF-20 at this pressure, confirming that introducing the methyl group did not significantly decrease the CO₂ uptake capacity. Importantly, at the high RH value of 70%, CALF-20M-w-HT and CALF-20M-e maintained approximately 0.5 and 0.6 mmol g⁻¹ of CO₂ capture capacity, respectively, whereas CALF-20 demonstrated no CO₂ uptake under these conditions, entirely compromising its carbon capture capability. In this Example, experimental and computational studies show how differences in the MOF structures resulted in distinct differences in performance for CO₂ capture in both dry and humid environments. More broadly, this Example indicates that these new methyl-triazolate-based sorbents are more suitable for post-combustion carbon capture applications that contain high humidity than their non-methylated counterpart.

### Materials and Methods

Materials. All chemicals were sourced from commercial vendors and utilized without further modification.

### Characterization and Measurement

Single-Crystal X-ray Diffraction. Single-crystal X-ray structure analysis of NU-220 and CALF-20M-w-LT were carried out at 100 K and 298 K, respectively, using a Rigaku Cu-Synergy diffractometer equipped with shutter-less electronic-noise free Hybrid Photon Counting (HPC) detector and Cryostream 80-500K (Cryostream Oxford Cryosystems, Oxford, United Kingdom), MoKα(λ=0.71073 Å)/CuKα(λ=1.54184 Å) microfocus source with a beam size of ˜110 μm and a 4-circle Kappa geometry goniometer. The structure of CALF-20M-e was collected at 293 K under vacuum conditions using MicroED (also named XtaLAB Synergy-ED) equipped with a Rigaku HyPix-ED direct electron detector and controlled by the software of Rigaku Oxford Diffraction CrysAlis^{Pro} program package. The electron optics of the XtaLAB Synergy-ED are based on a 200 kV electron gun with a lanthanum hexaboride crystal as the electron emitter. The structures were determined by intrinsic phasing (SHELXT 2018/2) and refined by full-matrix least-squares refinement (SHELXL-2018/3) using the Olex2 software packages. Refinement results were obtained (data not shown). Crystal structures in CIF format have been deposited in the Cambridge Crystallographic Data Centre (CCDC) under deposition number CCDC-2286353-2286355.

X-ray Diffraction Analyses. Powder X-ray diffraction (PXRD) profiles of MOFs were measured at room temperature using a STOE-STADIP powder diffractometer, fitted with an asymmetric curved Germanium monochromator (employing CuKα1 radiation, λ=1.54056 Å) and a one-dimensional silicon strip detector (MYTHEN2 1K from DECTRIS). The line-focused Cu X-ray source operated at 40 kV and 40 mA. The sample powder was positioned between two Kapton sheets and assessed in a transmission setup with a rotating holder.

Variable Temperature X-ray Diffraction Analyses. Activated samples were placed into glass capillaries with a diameter of 0.5 mm and approximately 1.0 cm thickness. To keep the samples in place, the capillaries were packed with 0.5 cm of glass fiber. The samples were then rapidly rotated while being heated from 298 K to 673 K. The heating rate was maintained at 5° C. per minute in ambient air, holding for 5 minutes at each designated temperature.

Pure Gas Sorption Measurements. All MOF sorbents were activated at 413 K for 24 hours under dynamic vacuum before collecting N₂, CO₂ and water sorption measurements for surface area and pure gas uptake capacity. N₂ isotherms were collected on a Micromeritics 3Flex instrument at 77 K and 298 K, and CO₂ and water isotherms were measured at 298 K on the same instrument.

Scanning electron micrographs (SEM) (data not provided). SEM images were captured using a Hitachi SU8030 at the EPIC facility (NUANCE Center-Northwestern University). Samples were loaded on a conductive carbon adhesive tape on an aluminum stub and coated with OₛO₄ to ˜15 nm thickness in a Denton Desk III TSC Sputter Coater before imaging.

Thermogravimetric analysis (TGA) (data not provided). MOF samples were carefully transferred to TGA for thermal stability using Discovery TGA5500 (TA Instruments, New Castle, USA) under flowing dry N₂ with the flow rate of 25 cc/min and ramp 5.00° C./min to 800.00° C.

Humid CO₂ capture measurements. A flow system (not shown) supplying dry N₂ (Airgas, ultra-high purity, 99.999%) and CO₂ (Airgas, research grade, 99.999%) of varying humidity was constructed. The system was leak checked by ensuring no decrease in the pressure for at least 10 minutes while pressurized to 5 psig with N₂. Alumina TGA holders loaded with powdered samples were placed in a 1″ outer diameter quartz tube. To activate the samples, the quartz tube was heated with a clamshell furnace (Lindberg/Blue M™ Mini-Mite™) under 100 sccm dry N₂ to 343 K at a ramp rate of 4° C. minute-1, held for 4 hours, then allowed to cool to room temperature. 75 sccm dry CO₂ was then bubbled through a gas diffuser in chilled deionized water (Thermo Fisher Scientific Neslab RTE7 Digital One recirculating chiller) to achieve the desired relative humidity. A dry CO₂ stream was mixed in to achieve relative humidities below 40%. The activated sample was saturated in the H₂O/CO₂ stream for >10 hours. A digital hygrometer (Incubator Warehouse™ HumidiKit™) downstream of the sample confirmed steady state and the final relative humidity.

The saturated sample was immediately capped with minimum exposure to ambient conditions and then transferred to a thermogravimetric analysis instrument equipped with gas chromatography mass spectrometry (TGA-GCMS). TGA-GCMS was conducted to measure the quantity of captured CO₂ using Netzsch STA 449 F3 “Jupiter” simultaneous thermal analyzer and Agilent 5973 GCMS. Throughout the desorption process, a flow rate of 25 mL/min of the carrier gas, dry argon (Ar), was maintained. After a 10-minute flow of Ar, the samples were heated to 413 K to release the adsorbed CO₂. The setup ensured that gases released from the sample in the TGA device were directed into the GCMS and the GCMS was triggered immediately in TGA temperature profile. During heating of the samples in the TGA, a gas injection was triggered every minute by an automated gas valve. The area corresponding to each peak/injection was integrated to quantify the results.

In situ gas sorption for PXRD analysis. In situ total scattering data suitable for powder X-ray diffraction (PXRD) analysis was collected at beamline 11-ID-B located within the Advanced Photon Source at the Argonne National Laboratory using high energy X-rays (0.2116 Å, ˜58.6 keV). X-ray scattering images were collected using an amorphous-silicon-based flat panel detector. OF samples were packed in polyimide capillaries of ˜1.1 mm outer diameter and then assembled in a flow cell furnace and activated at 423 K for 1 h. Data was collected under dry and moist gas atmosphere. To enrich the gas stream with moisture, a water filled bubbler was used. Data was collected for dry helium and CO₂ as well as water enriched (100% RH) helium and CO₂. The samples were reactivated between each measurement to drive out potential guests. Data were collected at sample-to-detector distances of ˜1000 mm for diffraction analysis. The detector geometry was calibrated based on the scattering data collected for a CeO₂ standard and GSAS-II was used to reduce obtained scattering images to one-dimensional scattering intensity data. PXRD data were analyzed using TOPAS. Lattice parameters, peak intensities and shapes were quantified following the Le Bail method and pseudo-Voigt functions as well as Rietveld based methods. Multivariate analysis including non-negative matrix factorization was carried out as described elsewhere.

Breakthrough tests. To assess the practical separation performance of the two phases, dynamic breakthrough tests were performed at 298 K and 1 bar using binary gas mixtures of CO₂ and N₂(15/85, v/v) under dry conditions, with a flow rate of 5.0 cm³/min. These experiments were carried out with a Micromeritics Breakthrough Analyzer (BTA) linked to a Pfeiffer mass spectrometer (GSD 350 02 Omnistar gas analysis system) at the outlet, allowing continuous monitoring and recording of the effluent gas composition. Stainless steel columns were packed with the well-activated MOF adsorbents to form the fixed bed. Prior to introducing the pre-mixed 15% CO₂ gas stream at a 5 sccm flow rate, the system was preheated under a dry Helium flow (20 sccm, 1 bar) for 2 hours at 100/180° C.

Cycling experiments. Cycling experiments for CO₂ adsorption were performed under dry conditions using thermogravimetric analysis (TGA). Sample activation for both pre-activated MOFs was conducted under flowing N₂ at 100/180° C. for 20 minutes, maintaining a consistent flow rate of 25 mL/min for all TGA experiments. After a 30-minute exposure to this binary mixture at 25° C., the samples were heated to 100/180° C. for 15 minutes to regenerate the sorbents.

### Synthesis and Activation of MOFs

CALF-20: 1H-1,2,4-triazole (7.2 mmol, 500 mg) and zinc oxalate (4.3 mmol, 660 mg) were added in 20 mL methanol and introduced into a 100 mL autoclave. The resulting mixture was vigorously stirred for 10 minutes and then subjected to incubation at 453 K for 3 days. Subsequently, the white precipitate was collected by centrifuge and subjected to three rounds of washing using methanol (10 mL ca.) before being dried under vacuum for 2 hours. Activation of the samples was carried out at 413 K for 12 hours prior to conducting the gas isotherms and following measurements.

NU-220:3-methyl-1H-1,2,4-triazole (6 mmol, 500 mg) and zinc oxalate (2.15 mmol, 330 mg) were added in 20 mL methanol and introduced into a 100 mL autoclave. The resulting mixture was vigorously stirred for 10 minutes and then subjected to incubation at 453 K for 3 days. Subsequently, the white precipitate was collected by centrifuge and subjected to three rounds of washing using methanol (10 mL ca.) before being dried under vacuum for 2 hours. 333 mg of white precipitation was collected. Activation of the samples was carried out at 413 K for 12 hours prior to conducting the gas isotherms and following measurements.

CALF-20M-w: 3-methyl-1H-1,2,4-triazole (6 mmol, 500 mg) and zinc oxalate (2.15 mmol, 330 mg) were added in 20 mL water and introduced into a 100 mL autoclave. The resulting mixture was vigorously stirred for 10 minutes and then subjected to incubation at 453 K for 3 days. Subsequently, the white precipitate was collected by centrifuge and subjected to three rounds of washing using water (10 mL ca.) and three additional washes using methanol before being dried under vacuum for 2 hours. 293 mg of white precipitation was collected. High temperature activation of the samples was carried out at 413 K for 12 hours prior to conducting gas isotherms and following measurements. High temperature provides CALF-20M-w-HT. Low temperature activation of the samples involves temperatures less than 100° C. and provides CALF-20M-w-LT.

CALF-20M-e: 3-methyl-1H-1,2,4-triazole (6 mmol, 500 mg) and zinc oxalate (2.15 mmol, 330 mg) were added in 20 mL ethanol and introduced into a 100 mL autoclave. The resulting mixture was vigorously stirred for 10 minutes and then subjected to incubation at 453 K for 3 days. Subsequently, the white precipitate was collected by centrifuge and subjected to three rounds of washing using ethanol (10 mL ea.) before being dried under vacuum for 2 hours. 230 mg of white precipitation was collected. Activation of the samples was carried out at 343 K for 12 hours prior to conducting gas isotherms and following measurements.

### Computational Details

### Quantum Chemical Calculations

To obtain partial charges on the MOF atoms, density functional theory (DFT) calculations were performed as implemented in VASP6.3.2 with PAW pseudopotentials. The energy cutoff was set to 600 eV, and the k-point grid to 4×4×2. The convergence criteria were set to 106 eV for electronic steps and 10⁻² eV/Å for ionic steps. In the geometry optimization, the change of the positions of ions was allowed for, and lattice parameters were fixed at experimental values. The PBE exchange-correlation functional together with D3 (BJ) dispersion correction was used to describe interactions within the simulated system. Partial charges were obtained using electron density with the DDEC6 population analysis method.

### Classical Simulations

The RASPA simulation package was used for all minimization and grand canonical Monte Carlo (GCMC) simulations. The partial atomic charges of the framework atoms were calculated utilizing the DDEC6 method. The structures of MOFs were obtained from DFT minimizations and were considered rigid for all simulations. A 12-6 Lennard-Jones (LJ) plus Coulomb potential was used for adsorbate-adsorbate and adsorbate-framework interactions. The LJ parameters for the framework atoms were taken from the DREIDING Force Field (DFF). The LJ parameters and partial charges of N₂ and water molecules were taken from the TraPPE force field and TIP4P model, respectively (data not shown). For CO₂ molecules, the LJ parameters and partial charges which predict the adsorption isotherm of CO₂ in zeolite LTA-4A were used, in very good agreement with the experimental isotherm. The Lorentz-Berthelot mixing rules were applied for interactions between unlike species. The LJ potential was terminated using a cutoff distance of 12.8 Å without considering the tail correction. The Ewald summation was used for long-range electrostatic interactions.

Energy Minimizations. The minimum energy structures and interaction energies for isolated guest molecules in each sorbent were found as follows. To ensure robust convergence to the global minimum, minimizations were performed for each adsorbate in each sorbent, commencing from 100 distinct random initial positions and a short equilibration. The lowest energy value obtained from these cycles is reported herein.

GCMC Simulations. To predict the adsorption isotherms of pure components, grand canonical Monte Carlo (GCMC) simulations were conducted at 298 K for pure CO₂ and water for comparison with experiment. In addition, simulations were performed at 313 K for all 3 gases, as this is a common temperature investigated for post-combustion CO₂ capture. To calculate the relative humidities in the simulations, the water saturation pressures for the TIP4P model of 4.59 kPa (SAT-TMMC: Liquid-Vapor coexistence properties-TIP4P Water (LRC), NIST) and 10.63 kPa at 298 K and 313 K, respectively, were used.

To investigate how relative humidity affects the CO₂ uptake, multicomponent isotherms at 313 K were also simulated using GCMC. The total pressure of the system was fixed at 1 bar, which is a typical flue gas condition. The gas-phase CO₂ mole fraction was fixed at 14% as a typical CO₂ concentration in flue gas from a coal-fired process, the relative humidity was varied from 1% to 95%, and the balance at each relative humidity was assumed to be nitrogen.

For CO₂ and N₂ GCMC simulations, identical probabilities of insertion/deletion, translation, rotation, and reinsertion Monte Carlo (MC) moves were used, while additional continuous fractional component MC moves were included for water simulations. A total of 100,000 initialization cycles and 100,000 production cycles were used to predict the uptake of pure CO₂ and N₂, where a cycle consists of N Monte Carlo moves and N is the maximum of the number of guest molecules in the system at the beginning of the cycle or 20. A total of 500,000 initialization cycles and 500,000 production cycles were used for the pure water and multicomponent uptake predictions. If the system did not reach equilibrium after these 1 million cycles, the simulations were continued for another 500,000 initialization cycles followed by another 500,000 production cycles.

### Results and Discussion

### Synthesis and Structural Characterization

To begin the investigation, the reactions of mtz with ZnOx in different solvents were screened. The individual components were pre-mixed in methanol, ethanol, or water separately and heated at 180° C. for 3 days in a Parr vessel. Similar to the synthesis of CALF-20, all three reactions generated a white material that precipitated out. Interestingly, powder X-ray diffraction (PXRD) analysis of the products indicated each of the three solvents produced a different crystalline material, which contrasts the behavior of CALF-20. In CALF-20, the N atoms in the 1,2 positions of the triazolate linker bridge Zn dimers, which were linked to the next dimer by the N atom in the 4-position. The Zn coordination was completed by two oxygen atoms of a chelating oxalate group, and there were no open coordination sites. Following the reaction in methanol, NU-220 crystallized in the tetragonal space group P4₃2₁2 (FIG. 1A) with a formula of [Zn(mtz)(ox)_{0.5}] and novel topology that differed from the monoclinic P2₁/c system known for CALF-20. NU-220 has three types of zinc moieties: 1) hexa-coordinated zinc where the metal center is connected with two triazolate linkers and two cis-oxalate linkers (Zn—O=2.093(4) and 2.189(4)Å; Zn—N=2.090(5); Å; 2) penta-coordinated zinc where it is connected with three triazolate linkers (Zn—N=2.034(5), 2.036(4) and 2.122(4), and one bridged oxalate linker (Zn—O=2.038(4) and 2.085(4)Å); 3) tetra-coordinated zinc that is connected to four triazolate linkers (Zn—N=1.983(5) and 2.022(4)Å.

In contrast, reactions in water (and low activation temperature) and ethanol led to the formation of CALF-20M-w-LT and CALF-20M-e, respectively, which crystallized in the monoclinic P2₁/c and orthorhombic Pbcn space groups, respectively, with a formula of [Zn(mtz)(ox)_{0.5}] (FIGS. 1C, 1D). Both MOFs exhibited penta-coordinated zinc ions in a distorted trigonal bipyramidal geometry. The Zn—O distances in CALF-20M-w-LT were 2.026(3)Å and 2.176(3)Å, while the Zn—N distances spanned 2.108(3)Å, 2.016(3)Å, and 2.037(3)Å. Similarly, CALF-20M-e features Zn—O distances of 2.00(5)Å and 2.12(3)Å and Zn—N distances of 1.99(5)Å, 2.05(5)Å, and 2.12(4)Å. Although the space group and unit formula of CALF-20M-w-LT resembled those of CALF-20, the structure of CALF-20M-w-LT differed. For instance, due to the steric hindrance of the methyl group in CALF-20M-w-LT, the interplanar angle between the oxalate group and the Zn₂(tz)₂ moiety was higher (63.65° compared to the analogous angle in CALF-20(50.85°, making CALF-20M-w-LT a unique isomer of CALF-20.

Structural analysis of CALF-20M-w-LT and CALF-20M-e unveiled noteworthy alterations in the pore properties relative to those of CALF-20 that arose from the presence of the methyl groups that lined the pores. Specifically, the pore apertures for CALF-20M-w-LT and CALF-20M-e were 3.4 Å×6.9 Å and 3.2 Å×3.2 Å, respectively, which were significantly reduced from the pore aperture of 5.2 Å×5.7 Å found in CALF-20. Notably, the structures of CALF-20M-w-LT and CALF-20M-e differed from one another in the orientation of the layers within each material. The triazolate layers in CALF-20M-w-LT exhibited a unidirectional arrangement, denoted as A-A-A, while those in CALF-20M-e display an alternating orientation pattern of A-B-A. This difference in layer orientation further impacted the dimensions of the pore channels, resulting in a smaller effective 1D channel and 18% reduction of unit cell volume for CALF-20M-e. In contrast, the triazolate layer in CALF-20 and its hydrated form do not adopt a similar configuration. As three different structures with the same linker were obtained by only varying the solvents used in the synthesis, it can be concluded that different solvents interact with MOF precursors and significantly influenced the nucleation, crystal growth, and self-assembly processes involved in the synthesis.

### Irreversible Solvent-Dependent Phase Transitions of Polymorphs

To investigate phase transitions among the three polymorphs, the corresponding MOFs (˜50 mg) were incubated at 453 K for 24 hours in two alternative solvents (10 mL) separately, and the dynamic response of the framework to solvent stimuli (e.g., methanol-synthesized NU-220 incubated in water and ethanol separately) was observed, highlighting the pivotal role of solvents in directing the structure from thermal kinetics aspects. The phase transitions were monitored using PXRD (FIG. 2F). Notably, incubating NU-220 in water at 453 K afforded a phase transition into CALF-20M-w-LT, but this transition was not observed upon incubation of NU-220 in ethanol under otherwise analogous conditions (data not shown). This phase transition was found to be irreversible, as incubating CALF-20M-w-LT in methanol at 453 K for 24 hours failed to induce the transformation back to the NU-220 phase (data not sown). However, incubating CALF-20M-w-LT in ethanol resulted in an unexpected transition to a new phase that exhibited slight differences from CALF-20M-e, as evidenced by variations in peak positions in the PXRD patterns (data not shown). Specifically, the 2θ values of peaks originally located at 10.3°, 13.9°, and 15.0° in CALF-20M-w-LT shifted to 10.5°, 13.4°, and 14.2°, respectively, and the peak at 13.2° in CALF-20M-e was absent from the pattern for the new material. Nevertheless, upon analyzing the CO₂ isotherms, it is evident that the similarity in shape and trend closely aligned with that observed in CALF-20M-w-LT (data not shown), suggesting that ethanol initiated structural transformations, but these ethanol-induced changes were insufficient to fully reorient the triazolate-layer to match the orientation observed in CALF-20M-w-LT. A similar phenomenon was observed after incubating CALF-20M-e in water, supporting an irreversible transition to CALF-20M-w-LT (data not shown).

The effects could encompass diverse mechanisms, including lattice swelling or contraction, solvent coordination, and hydrogen bonding. It was hypothesized that during the synthesis of CALF-20M-c, the solvent ethanol served as a template and filled the voids within the structure. However, the ultramicroporous space of CALF-20M-w-LT limited the diffusion of ethanol and hindered the phase transition of CALF-20M-w-LT to CALF-20M-c. Meanwhile, a potential energy barrier inhibited the reversal of the triazolate layers from the A-B-A pattern in CALF-20M-e to the A-A-A pattern in CALF-20M-w-LT. Variations between solvents, including differences in polarity, coordinating abilities, and hydrogen bonding capabilities, afforded varying effects on the coordination environment, intermolecular interactions, and packing arrangements within the MOF structure. In these materials, solvents interacted with the structural components to induce alterations in the packing arrangement and bonding interactions, resulting in a dynamic response at elevated temperatures. For instance, methanol displayed intermediate polarity and molecular size in comparison to water and ethanol. The presence of a larger dipole moment and fewer carbon atoms in methanol resulted in stronger hydrogen bonding and dipole-dipole interactions compared to ethanol. The same phase products were observed in propanol (1-propanol and isopropanol) and butanol (data not shown), and a binary mixture of water and ethanol resulted in an A-A-A pattern like CALF-20M-w-LT. Methanol potentially served as a template with proper molecular dimension for the growth of the framework around methanol molecules in NU-220. Overall, these experimental findings suggest that the solvent not only had effects during the nucleation, crystal growth, and self-assembly processes, but also contributed to the phase transition behavior of these MOFs under different media.

### Analysis of Pure Gas and Vapor Adsorption.

CO₂ sorption isotherms for NU-220, CALF-20M-w-HT, CALF-20M-c, and CALF-20 were then collected at 298 K, and it was observed that the shape of the CALF-20M-w-HT isotherm closely resembled that of CALF-20, while the isotherms of NU-220 and CALF-20M-c featured slightly different shapes based on the slope of the plateau region (FIG. 2A). Notably, the CO₂ isotherm for CALF-20M-w-HT exhibited an uptake of 1.0 mmol g⁻¹ at 13 mbar, which is comparable to that of CALF-20 at this pressure, but the CALF-20M-w-HT isotherm was shifted downward at higher pressures compared to the CALF-20 isotherm due to the reduced total pore volume (FIG. 2B). Interestingly, CALF-20M-e demonstrated the highest CO₂ adsorption of ˜1.87 mmol g⁻¹ among the four sorbents at low CO₂ concentrations of ˜0.03 bar, and it reached a plateau of 2.05 mmol g⁻¹ at 0.15 bar. The calculated heats of adsorption (Qₛₜ) of approximately 35-50 kJ mol⁻¹ for CALF-20, NU-220, CALF-20M-w-HT and CALF-20M-e indicate that physisorption played a dominant role in the CO₂ capture mechanism (FIG. 2C). The Qₛₜ values were calculated based on three isotherms at 273, 298 and 313 K and fitted with the virial method (data not shown). Among these four adsorbents, CALF-20M-e exhibited the highest calculated Qₛₜ value of 50 KJ mol⁻¹, indicating this MOF featured the strongest interactions for CO₂ capture among this series. The experimentally observed trend for Qₛₜ values (CALF-20M-e>CALF-20M-w-HT>NU-220≈CALF-20) matched well with the sequence of adsorption energies calculated by finding the minimum energy for a single adsorbate molecule in the MOFs using a classical force field (Table 1).

Notably, it was observed that the CO₂ isotherms in NU-220 and CALF-20M-e reach saturation before 0.2 bar, while the CALF-20 and CALF-20M-w-HT isotherms continued to rise over the pressure range studied. Furthermore, it was observed that for CALF-20M-e the isotherms at 313 K and 298 K exhibited a plateau (data not shown), but when the temperature decreased to 273 K, the CO₂ isotherm did not plateau and exhibited a gradual increase in CO₂ uptake up to 1 bar, suggesting structural flexibility and a variation in the adsorption mechanism (data not shown), which is not observed in NU-220 (data not shown).

Next, H₂O sorption isotherms were obtained at 298 K for CALF-20, NU-220, CALF-20M-w-HT, CALF-20M-e, with the results presented in FIG. 2D. The water isotherm in CALF-20 exhibited an inflection point around 10% RH and had the highest uptake at higher RH, approaching ˜8 mmol/g at 35% RH. NU-220 reached ˜5 mmol/g of water sorption at approximately 20% RH, with a more gradual increase at higher RH. CALF-20M-w-HT and CALF-20M-e generally exhibited lower water uptake than CALF-20 and NU-220, suggesting a diminished affinity between water and the sorbent pores. At very low RH (below 10% RH), however, the three new polymorphs actually showed higher water uptake than CALF-20. In principle, the methyl group in the mtz linker of NU-220, CALF-20M-w-HT and CALF-20M-e should increase the hydrophobicity of the pores relative to that of the non-methylated linker in CALF-20. It is, thus, surprising that the isotherms in FIG. 2D show that the new MOFs containing methyl groups exhibited higher water adsorption than CALF-20 at low RH. The surprising increase in hydrophilicity of the methyl-containing MOFs seen in FIG. 2D is consistent with the water adsorption energies calculated from atomistic modeling in Table 1.

TABLE 1
Adsorption energy of a single adsorbate molecule (kJ/mol) after
energy minimization utilizing classical force field and experimental
heat of adsorption (Qₛₜ) for all four sorbents.

| Structure | Qₛₜ (CO₂) | CO₂ | H₂O | N₂ |
|---|---|---|---|---|
| CALF-20 | 36.8 (±0.2) | −39.9 | −42.1 | −22.4 |
| NU-220 | 36.3 (±0.1) | −44.1 | −49.1 | −24.5 |
| CALF-20M-w-LT | 41.9 (±1.4) | −48.6 | −50.9 | −24.8 |
| CALF-20M-e | 49.3 (±0.5) | −53.0 | −50.9 | −25.3 |

From the CO₂ and water isotherms, it was seen that the reduced pore sizes of CALF-20M-w-HT and CALF-20M-e not only enhanced CO₂ uptake but also suppressed H₂O adsorption at low pressures. The minimal N₂ adsorption at 77 K in CALF-20M-w and CALF-20M-e (data not shown) was consistent with smaller pores.

### Accelerated Aging and Thermal Stability Characterization.

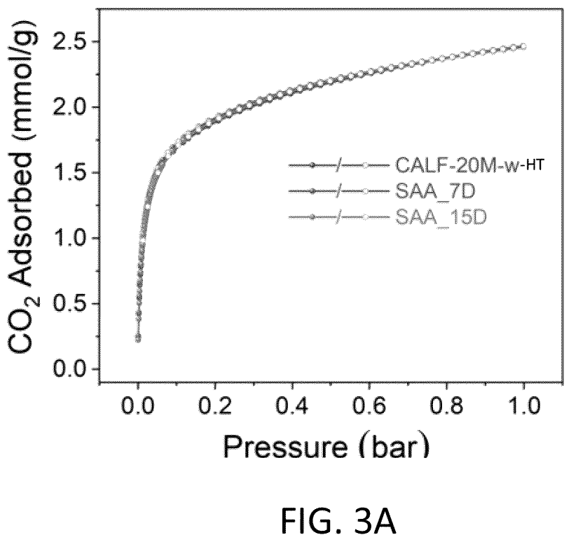

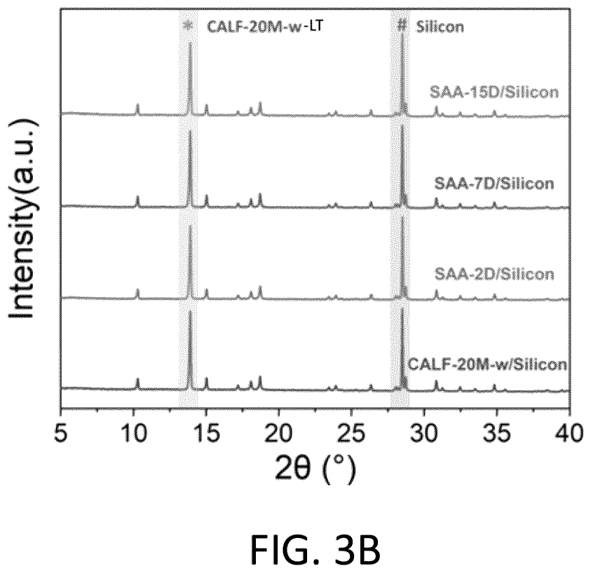

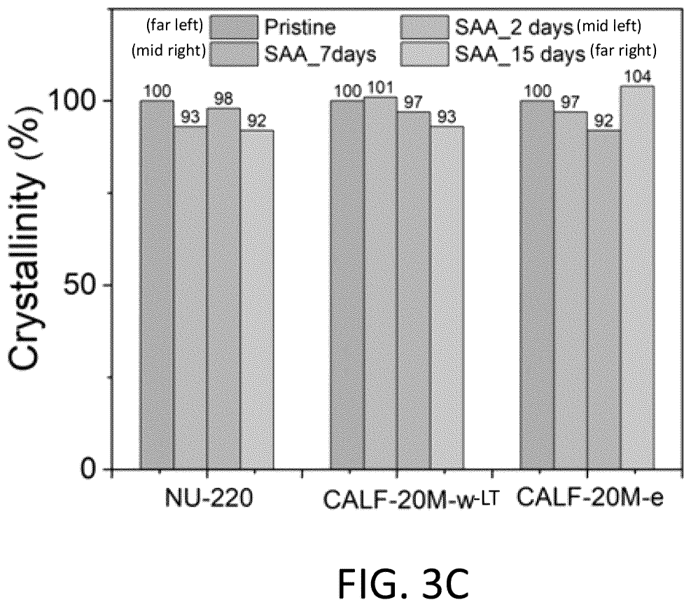

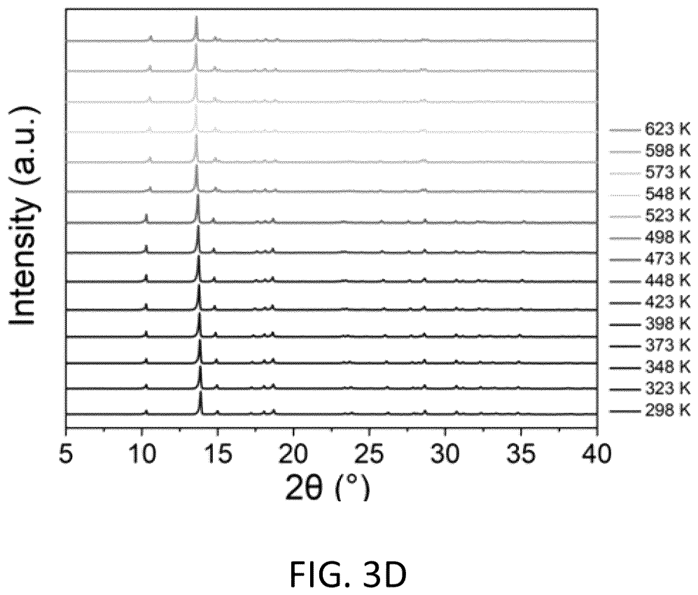

The stability and regenerability of CO₂ sorbents are critical factors in their suitability for operational conditions and efficient CO₂ capture in flue gas systems. Long-term stability is paramount to ensure the extended lifespan of sorbents, including in the presence of competing gases and vapors. To evaluate the stability of the activated samples under harsh conditions of elevated temperatures and high RH, standardized accelerated aging (SAA) experiments were conducted. Specifically, the activated sorbents were incubated in a humidity oven at 343 K and 80% RH for 15 days to accelerate the aging process. To evaluate the degradation rate of sorbents, the aged samples were re-activated, and their CO₂ sorption isotherms were measured after 7 and 15 days. It was found that all three sorbents exhibit consistent CO₂ isotherms throughout the aging process, confirming their stability (FIG. 3A).

Additionally, a quantitative analysis of PXRD patterns was performed to directly assess the changes in crystallinity utilizing silicon as an internal standard (data not sown). Specifically, the ratio of peak intensities (R=p1/p2) were evaluated, where p1 represents the intensity of the selected characteristic peak of the sorbent and p2 corresponds to the intensity of silicon. (In pure silicon, both p1 and p2 represent two different peaks from silicon.) To account for potential fluctuating mass effects on diffraction intensity, a small portion of the sample was taken from the pre-mixed samples for PXRD during SAA experiments. To quantify the crystallinity changes, the characteristic peaks of NU-220 at 13.66° {201} (data not shown), CALF-20M-w-LT at 13.91° {001} (FIG. 3B), CALF-20M-e at 13.79°{110} (data not shown) for the sorbents (p1), and 28.52° {111} (p2) for silicon were selected, respectively. The results provided comparable R values for the characteristic diffraction peaks in all three aged sorbents, indicating unchanged crystallinity. R values for NU-220, CALF-20M-w-LT and CALF-20M-e fluctuated in the range of 0.84-1.00, 0.89-0.97 and 0.33-0.37, respectively (data not shown). The crystallinity (R/R₀, where R₀ represents the R value before aging) of each material was evaluated based on the relative R values, and it was found that for all cases, the quality of each crystalline structure showed only negligible degradation (FIG. 3C). Scanning electron microscopy (SEM) was then employed to corroborate these observations, and it was verified that minimal changes in particle size and morphology occurred following the aging measurements (data not shown), further supporting the remarkable stability of three sorbents under the specified conditions.

Following SAA stability assessments, attention was shifted to probing the thermal stability of NU-220, CALF-20M-w-LT, and CALF-20M-c, and variable-temperature PXRD (VT-PXRD) measurements from 298 to 673 K were conducted. Remarkably, NU-220 and CALF-20M-w-LT preserved their structural integrity up to 648 K (FIG. 3D), while CALF-20M-e underwent a loss of crystallinity at 623 K (data not shown). The results align well with the findings from the thermal gravimetric analysis (TGA) (data not shown), where sorbents started losing weight around 623 K. Moreover, the VT-PXRD analysis of CALF-20M-w-LT revealed distinctive evidence of structural flexibility, as some of the peaks shifted positions—a phenomenon absent in NU-220 (data not sown). For instance, the characteristic peaks at 10.31° {110} and 13.69° {011} shifted to 10.58° and 13.63° at 448 K, indicating a variable unit cell at elevated temperature (data not shown). This was also observed in CALF-20M-e where the peaks shifted from 23.87° to 23.53° (data not shown). Overall, these experiments illustrate the high thermal stability of these materials.

### Modeling Analysis

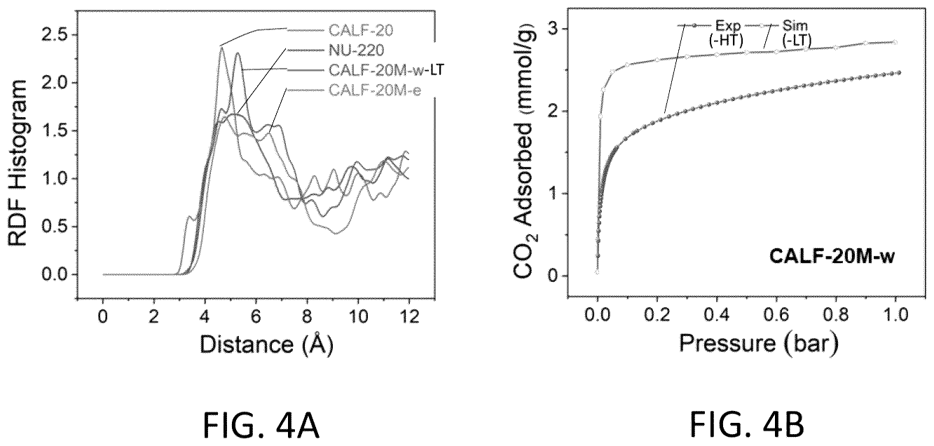

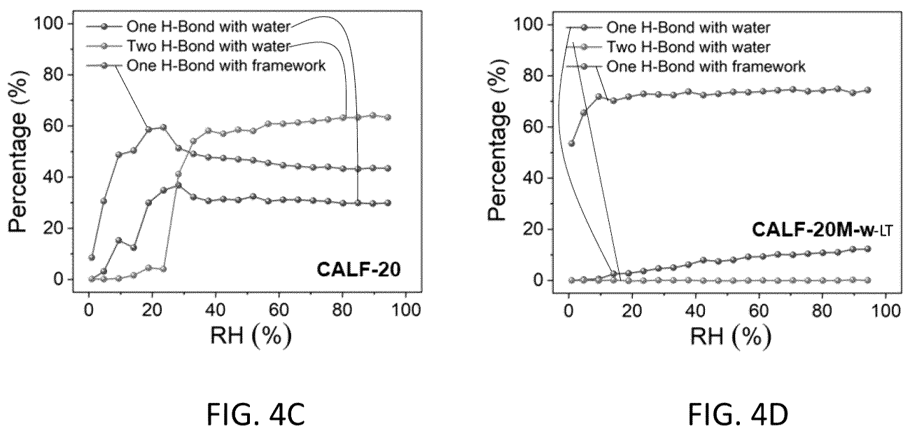

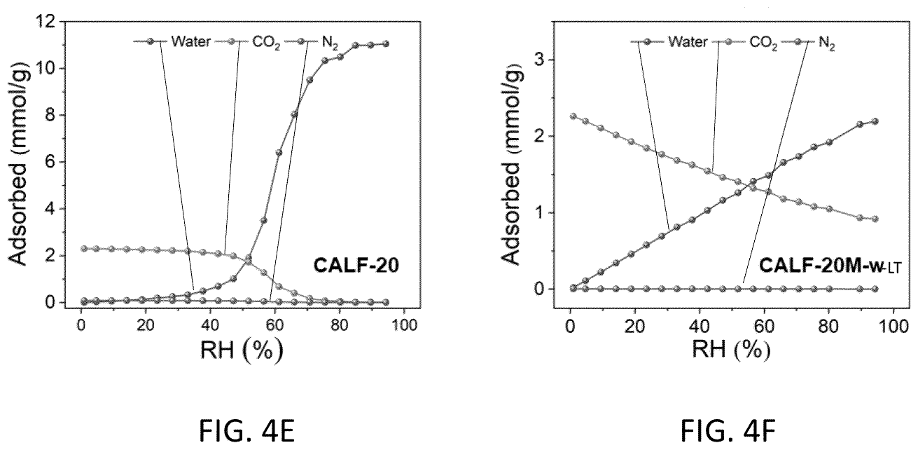

To better understand the behavior of these MOF sorbents, grand canonical Monte Carlo (GCMC) simulations were performed. First, to elucidate the demonstrated robustness under SAA conditions, pure water adsorption was simulated, and the distribution of water molecules within the framework was examined. The distance between the Zn—N bonds and adsorbed water molecules was quantified by the radial distribution function (RDF) at 95% RH. As illustrated in FIG. 4A, CALF-20 shows the minimal distance (<4.0 Å) between water and the Zn—N bond, suggesting a heightened likelihood of water disrupting the Zn—N bond through substitution. Conversely, the shortest distances greater than 4 Å were observed in NU-220, CALF-20M-w-LT, and CALF-20M-c. Although a distance of ˜3 Å is insufficient to form a Zn-water coordination bond in CALF-20, the incorporation of bulky methyl groups into the triazolate linkers further impeded water proximity to Zn—N bonds, thereby bolstering the framework's robustness to a higher level.

The minimum interaction energy between a single molecule (CO₂, H₂O, or N₂) and each sorbent was calculated using the same force field as used for the GCMC simulations. As shown in Table 1, N₂ had a very similar interaction energy with all four sorbents, whereas water had similar interaction energies (around −50 KJ/mol) with NU-220, CALF-20M-w-LT, and CALF-20M-e but a less favorable interaction (−42.1 kJ/mol) with CALF-20. Given that the newer adsorbents contained methyl groups-which were added due to their supposed hydrophobicity—this is surprising. However, as noted above, the results are consistent with the low-pressure trends in the experimental water isotherms (FIG. 2D). For CO₂, the interaction energies increased in magnitude in the order CALF-20<NU-220<CALF-20M-w-LT<CALF-20M-e (Table 1). To discern the primary factors contributing to the higher CO₂ adsorption energies for the latter three MOFs, the van der Waals (vdW) and Coulombic contributions of each atom in the CO₂ molecule with the MOF frameworks were examined. From the results (data not shown), it was seen that the total vdW energy consistently surpassed the total Coulombic energy. Although the vdW contribution of each CO₂ oxygen ([O]—C—O and O—C—[O]) exceeded that of carbon (O—[C]—O), both contributions were found to be favorable (<0). On the other hand, the Coulombic interactions of the CO₂ carbon atoms with the MOF were favorable, while those of the CO₂ oxygen atoms were unfavorable. This suggests that the CO₂ carbon atoms preferentially formed favorable interactions with negatively charged framework atoms like oxygen and nitrogen, and it was the increased Coulombic interaction that made CO₂ adsorption more favorable in CALF-20M-c than CALF-20 (−17.4 versus-8.7 KJ/mol).

Next, the single-component CO₂ and water isotherms for all four sorbents were determined by GCMC simulations. The simulated results for CO₂ at 298 K closely matched the experimental isotherms for CALF-20 and NU-220 (data not shown), and for CALF-20M-w-LT and CALF-20M-e, the simulated isotherms had the same shape as those from the experiment, but with higher loadings predicted at higher pressures (FIG. 4B). Water isotherms tend to be more difficult to predict, and the agreement between simulation and experiment (data not shown) is reasonably good, with similar trends as seen in the experiment. To elucidate the hydrophilicity trend, the adsorbate-adsorbate energy, host-adsorbate energy, and total potential energy of all sorbents were calculated as a function of RH (FIG. 4C).

In the case of CALF-20, the water-water interactions increased dramatically around 25% RH, which is also the range where the isotherm rose sharply, suggesting the emergence of a hydrogen bonding network among water molecules (data not shown). This was also observed in NU-220 (data not shown) but at even lower RH values (<20% RH). In contrast, CALF-20M-w-LT and CALF-20M-e demonstrated minimal water-water interactions (data not shown), demonstrating that the modifications in pore dimension and shape dramatically impacted the ability of water to form hydrogen bonding networks. This observation suggests that methyl functionalization presents a promising opportunity for CALF-20M-w-LT and CALF-20M-e to effectively capture CO₂ under high humidity conditions.

To compare the water network in all frameworks, the distribution of water molecules in the pores at 95% RH was visualized (data not shown), and the proportion of water molecules that form hydrogen bonds with other water molecules and with the framework (FIGS. 4C and 4D) was quantified. The criteria to define a hydrogen bond were an O—H—O angle greater than 150° and an O—H distance less than 2.5 Å. The results show that both CALF-20 and NU-220 contained a significant proportion of molecules that formed two hydrogen bonds with other water molecules, consistent with the conclusion from the water-water potential energy analysis (data not shown). On the other hand, CALF-20M-w-LT and CALF-20M-e showed very few water molecules forming two hydrogen bonds with other water molecules. Analysis of the hydrogen bonds between water molecules and the framework showed that hydrogen bonding with the oxalate groups was particularly favored, and all four materials had a high fraction of water molecules that formed one hydrogen bond with the framework.

Finally, competitive isotherms were simulated with the total pressure fixed at 1 bar, the gas-phase mole fraction of CO₂ fixed at 14%, variable RH, and the balance of the gas phase as nitrogen. The results in FIGS. 4E and 4F show that the loading of CO₂ in CALF-20 dropped dramatically when the humidity exceeded 40% RH, and nearly no adsorption was observed at 75% RH (FIG. 4E). However, the presence of methyl groups enabled CALF-20M-w-LT to retain a CO₂ capacity of ˜0.8 mmol/g even when the RH reached 90% (FIG. 4F).

### Dynamic Breakthrough and Competitive CO₂ Capture Under Humidity

Inspired by the multicomponent GCMC results, the CO₂/N₂ separation performance of NU-220, CALF-20M-w-HT, and CALF-20M-e was assessed through pure gas isotherms and kinetic experimental breakthrough tests. The pure CO₂ and N₂ sorption isotherms for the four sorbents were measured at 298 K (FIG. 5A) and employed with ideal adsorbed solution theory (IAST) to assess the separation performance. NU-220 showed a somewhat higher selectivity (440 versus 350 at 1 bar) for CO₂ over N₂(15/85, v/v) compared to CALF-20 (data not shown). However, CALF-20M-w-HT and CALF-20M-e displayed negligible single-component N₂ uptake at 298 K, suggesting even higher selectivity. Next, dynamic column breakthrough experiments (DCB) were performed to more directly examine the CO₂/N₂ separation performance for these MOFs. A binary mixture of CO₂/N₂ with a composition of 15/85 (v/v), representing a typical flue gas composition, was passed through a packed column containing glass beads and the sorbents. All three polymorphs exhibited sharp breakthrough curves in the N₂ profile, indicating rapid breakthrough of N₂ (FIG. 5B), without noticeable changes after three cycles (data not shown). In addition, distinct breakthrough retention times were observed for the CO₂ concentration profiles for each MOF. Specifically, the retention times as shown in FIG. 5B followed the sequence: NU-220(55 min g-1)>CALF-20M-e (48 min g-1)>CALF-20M-w-HT (33 min g-1). The elution times aligned closely with the CO₂ amount adsorbed at 0.15 bar, suggesting that the uptake capacity was the primary factor in the retention.

Considering the adsorption energies in Table 1, the relevance of N₂ uptake within this Example was minor, and preferential adsorption of either CO₂ or H₂O was indicated in both simulations and experiments, signifying a pronounced CO₂ to N₂ selectivity especially for CALF-20M-w-HT and CALF-20M-c. To probe the CO₂ uptake performance for these MOFs in the presence of humidity, an experimental setup was employed involving humid CO₂ capture experiments using a flow gas system in which each sorbent was subjected to streams of CO₂ with varying RH values. Specifically, the sorbent samples were placed in a ceramic container and positioned within a tube furnace. To ensure proper activation, the sorbents were treated with dry nitrogen followed by heating to 413 K before cooling to room temperature for humid CO₂ capture experiments. Next, the subsequent analysis was performed using a thermogravimetric analysis instrument equipped with gas chromatography mass spectrometry (TGA-GCMS) to accurately measure the quantity of loaded CO₂. For desorption experiments, the sorbent samples were heated to 413 K under a continuous flow of Ar as the carrier gas. GC-MS analysis enabled the identification and quantification of the amount of the resulting exhaust gases, which contained CO₂ and H₂O. Notably, the experimentally quantified amount of CO₂ adsorbed was inevitably underestimated compared to the actual amount adsorbed due to the slight loss of CO₂ that occurred during the transfer/mounting of saturated sorbents from the furnace to the TGA-GCMS instrument, which necessitated exposure of the samples to ambient conditions after uncapping.

The results in FIG. 5C illustrate a gradual reduction in the CO₂ adsorption capacity of CALF-20 as the RH increased. Eventually, at an RH level of ˜70%, the CO₂ adsorption capacity approached zero, and water emerged as the dominant adsorbed species at high RH. A comparable trend was seen in NU-220, where there was a marked reduction in CO₂ absorption at around 60% RH, but it maintained higher capture efficiency below 30% RH (FIG. 5D). Consequently, NU-220 proved unsuitable for capturing CO₂ from humid flue gas, as the CO₂ uptake became negligible around 60% RH.

On the other hand, the results for CALF-20M-w-HT and CALF-20M-e in FIGS. 5C and 5D revealed that some CO₂ capacity remained even at high humidity levels. Unlike in the case of NU-220, the methyl functional groups in CALF-20M-w-HT and CALF-20M-e efficiently limited the formation of hydrogen bonding networks, as discussed above. These two sorbents exhibited superior CO₂ uptake capacity above 45% and 55% RH, approximately 1.0 and 0.7 mmol/g CO₂, respectively, despite lower inherent pore volumes compared to that of CALF-20. The large amount of water uptake observed in single-component water isotherms in CALF-20 (FIG. 2D) resulted in a loss of approximately 30% in CO₂ uptake efficiency at 20% RH in the multicomponent measurements. In contrast, CALF-20M-w-HT and CALF-20M-e demonstrated a more gradual decrease in CO₂ capture performance with increasing RH, showing 20% CO₂ uptake capacity at 80% RH. These results are qualitatively consistent with the modeling results (FIG. 4H) and suggest that CALF-20M-w-HT and CALF-20M-e provide considerable promise for CO₂ capture from moist flue gas compared to CALF-20 under the same humid conditions.

A potential reason for the difference between the simulated and experimental pure and multicomponent isotherms for CALF-20M-w-LT and CALF-20M-e is structural flexibility of the MOFs (FIGS. 4B and 4F). Thus, in situ PXRD measurements were carried out with CO₂ sorption to investigate the structural changes during CO₂ capture. The activated sample was loaded under dry conditions with dry helium (dHe), dry CO₂ (dCO₂), and under humid conditions with humid helium (wHe) and humid CO₂ (wCO₂). The PXRD data (FIGS. 5E and 5F) is presented for the sample subjected to gas adsorption and desorption cycles, transitioning between dry and humid conditions. A Pawley refinement for the model for NU-220 was performed to determine the purity (data not shown). Notably, the annotated reflections {110}, {111}, and {211} in NU-220 (FIG. 5E) demonstrated diminished intensity, potentially attributable to the CO₂ uptake, signifying an almost instantaneous structural transition that remained reversible. Crucially, the intrinsic order of the MOF remained predominantly unaltered under these conditions, even at elevated RH levels, indicating the rigid structure of NU-220. Subsequently, an analogous in situ PXRD analysis was performed for CALF-20M-w-HT and CALF-20M-e, against the data for helium-loaded samples under dry and humid conditions. FIG. 5F shows the PXRD patterns of CALF-20M-w-HT throughout the whole dHe, dCO₂, wHe, wCO₂ adsorption cycle. During dry and humid CO₂ capture, characteristic peaks at 1.86° (annotated reflection {011}) shifted to 1.88°, demonstrating the structural alternation in CALF-20M-w-HT during CO₂ capture (FIG. 5F). The observed decrease in intensity of the annotated reflection {11-1} in CALF-20M-w-HT can be attributed to the adsorption of CO₂. A similar observation was made with the annotated reflection {110} of CALF-20M-e, where the peak shifted from 1.85° to 1.87° (data not shown). The in situ gas loading experiments successfully demonstrated the structural transition during wCO₂ capture and helped explain the difference between experimental results and simulation for mixture adsorption. For instance, the simulated multicomponent isotherms for CALF-20M-e did not indicate any large changes in CO₂ uptake at elevated RH values, which remained at >90% of the initial CO₂ uptake, even under 100% RH (data not shown). In contrast, experimental results indicated CALF-20M-e preserved only ˜20% of its initial CO₂ uptake capacity at 80% RH, which is significantly lower than the value predicted by simulation. As for CALF-20M-w-HT, even when accounting for the inherent loss of sequestered CO₂, it retains 23% of its efficiency experimentally, in contrast to the 57% projected by the modeling. Despite the structural flexibility demonstrated by CALF-20M-w-HT and CALF-20M-c, these experimental results still highlight their great potential for capturing CO₂ from highly humid flue gas.

### Abnormal Water Isotherm of CALF-20M-w

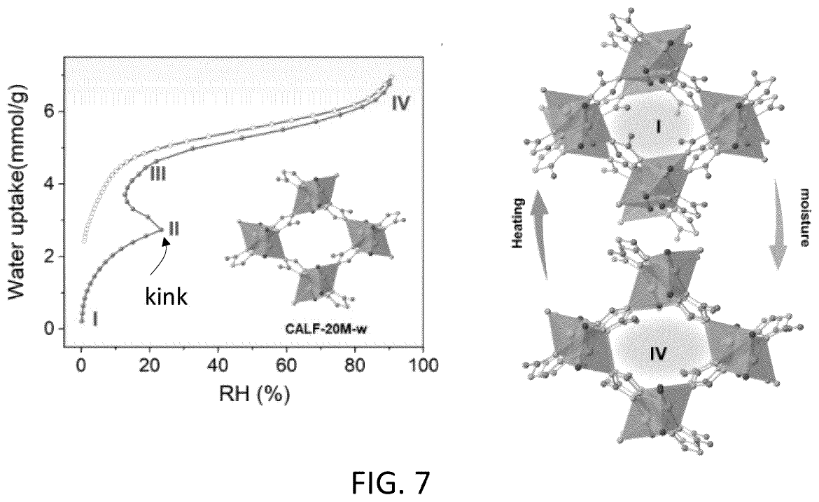

While typical water isotherms are L-shaped and S-shaped, the methylated CALF-20 derivative reported by our group, CALF-20M-w, exhibits an atypical, kinked S-shaped isotherm (FIG. 7) when activated at high temperature, which suggests the coupling of a multi-step structure transition (I to II to III to IV) to the water adsorption. Unlike rigid MOFs, for which adsorption isotherms are categorized into Type I-VI by IUPAC, flexible MOFs can exhibit more complex emergent behavior during adsorption due to the cooperative interplay of the framework and guest molecules. These guest-framework interactions can trigger phenomena such as gate-opening or breathing. The S-shaped kinked water isotherm in CALF-20M-w (FIG. 7) is unconventional and cannot be defined according to the standard IUPAC classifications, showing a unique, history dependent adsorption-desorption that is hypothesized to arise from the specific interactions between the MOF and the adsorbate. The research in this Example elucidates the fundamental phenomena that underlie the abnormal sorption behavior seen in CALF-20M-w at different levels of relative humidity, which yield new perspectives on the interplay between water molecules and MOF structures. Using advanced characterization methods, including in situ/ex situ single-crystal and adsorption isotherm analysis, the structural transformations of MOFs across different hydration phases was documented and it was found that the topological connectivity was retained during the transition without undergoing irreversible changes or degradation. Initially, the water isotherm is Type I, but as the water vapor dosing increases, the relative pressure surprisingly gives a negative increment after equilibration for an extended time (FIG. 7).

### Single Component Isotherms for Two Phases of CALF-20M-w

Initial data demonstrate that the structural dynamics of MOFs during water isotherms are both tunable and reversible by controlling humidity and activation temperature. The specific reversibility and mechanism are heavily dependent on the methylated triazole linker, which allows water to trigger the linker rotation during water sorption and stabilize the structure after overcoming the energy barrier by heating process. Notably, this behavior was not observed in the original CALF-20 case, highlighting how a small change in the triazolate linker structure affords unique properties to the resulting MOF. A typical Type I isotherm during water adsorption was obtained when CALF-20M-w was activated at low temperature but the S-shaped, kinked isotherm was obtained when CALF-20M-w was activated at high temperature (FIG. 8A). The sorption behavior of samples with different activation conditions indicates that the dynamic vacuum activation at high temperature (>120° C.) results in a phase I structure (denoted as CALF-20M-w-HT), while a phase IV structure (denoted as CALF-20M-w-LT) can be obtained when activated under lower temperature (<100° C.), showing the typical Type I water isotherm. Notably, CALF-20M-w-LT demonstrates a 50% improvement in CO₂ uptake, increasing from 1.8 to 2.6 mmol/g at 0.15 bar. (FIG. 8B.) It is believed that the heating below a threshold temperature fails to overcome the energy barrier required for the phase transition, which involves the rotation of the triazole linkers connecting two adjacent Zn centers (schematic to the right of FIG. 8B).

### Dynamic Breakthrough Experiments

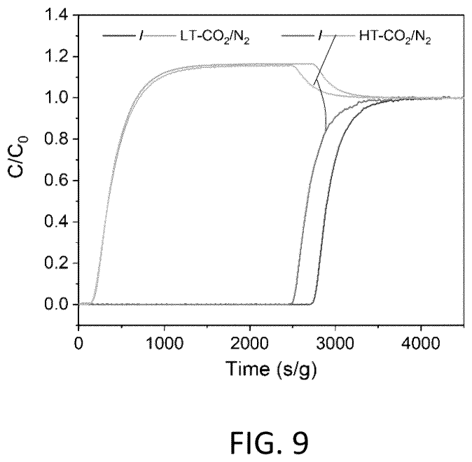

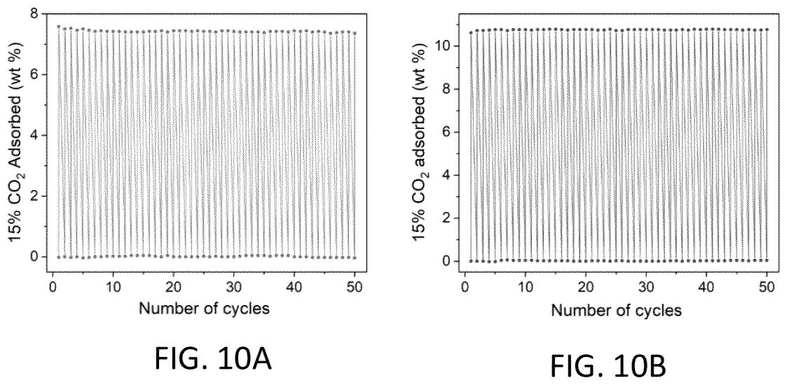

To assess the practical separation performance of the two phases, dynamic breakthrough tests were performed at 298 K and 1 bar using binary gas mixtures of CO₂ and N₂(15/85, v/v) under dry conditions (FIG. 9), with a flow rate of 5.0 cm³/min. Prior to introducing the pre-mixed 15% CO₂ gas stream at a 5 sccm flow rate, the system was preheated under a dry Helium flow (20 sccm, 1 bar) for 2 hours at 100° C. for CALF-20M-w-LT and 180° C. for CALF-20M-w-HT. In breakthrough test, N₂ was the first to elute and reach saturation, with minimal CO₂ detected, while CO₂ exhibited a delayed breakthrough, underscoring the framework's gas separation capability. Under dry conditions, CO₂ breakthrough times were 2344 s/g for CALF-20M-w-HT and 2582 s/g for CALF-20M-w-LT, reflecting a 10% improvement in CO₂ adsorption capacity in these dynamic conditions.

### Cycling Experiments

Given that typical post-combustion flue gas mixtures contain approximately 15% CO₂, with nitrogen as the other primary component, it is essential to evaluate the material's recyclability under a 15% CO₂ and 85% N₂ mixture. Sample activation for both pre-activated MOFs was conducted under flowing N₂ at 100° C. for 20 minutes for CALF-20M-w-LT and at 180° C. for CALF-20M-w-HT, maintaining a consistent flow rate of 25 mL/min for all TGA experiments. After a 30-minute exposure to this binary mixture at 25° C., the samples were heated to 100° C. for CALF-20M-w-LT and 180° C. for CALF-20M-w-HT for 15 minutes, resulting in a mass loss of 7.4% and 10.7%, respectively. Following 50 cycles (adsorption at 25° C. for 30 minutes, desorption at 100/180° C. for 15 minutes), no loss in adsorption capacity was observed (FIG. 9). CALF-20M-w-LT demonstrated a 45% improvement over CALF-20M-w-HT, increasing from 1.7 to 2.5 mmol/g in CO₂ capacity, aligning with theoretical values of 1.8 and 2.6 mmol/g, respectively.

### Mixed Linker of CALF-20 for Improved the Selectivity in Humid CO₂ Capture

This Example also incorporates methylated triazole linkers into CALF-20 to adjust adsorption properties while preserving the CALF-20 structure, with mtz contents at 4.8%, 13.8%, and 33.8% as verified by H₁ NMR. This approach aims to modify the MOF's surface chemistry and pore environment, enhancing selectivity for targeted applications. The CO₂ adsorption isotherm (FIG. 11A) shows that unmodified CALF-20 achieves the highest CO₂ uptake (3.8 mmol/g at 1 bar), while CO₂ capacity decreases as mtz content rises. At typical flue gas concentrations (15% CO₂, or 0.15 bar), CO₂ uptake reaches 2.7, 2.4, 2.0, and 1.7 mmol/g for CALF-20 and mtz-modified samples, respectively, representing only a 12% decrease for 4.8% mtz and a 35.4% decrease for 33.8% mtz. The H₂O adsorption isotherm (FIG. 11B) shows that lower mtz levels (4.8% and 13.8%) significantly reduce water uptake, with capacities of 7.6 and 6.8 mmol/g, respectively, down from 9.0 mmol/g at 50% relative humidity, indicating decreased hydrophilicity. This dual-linker strategy highlights CALF-20's tunable adsorption profile, offering potential in selective gas separation or moisture-sensitive environments and showcasing the benefits of linker modification for optimized MOF performance.

### CONCLUSION

This Example demonstrated that incorporating methyl groups into triazolate linkers affords robust materials better tailored than the comparative material without methyl groups to capture CO₂ from post-combustion flue gas in the presence of water. Specifically, new MOFs were synthesized, denoted as NU-220, CALF-20M-w-HT, CALF-20M-w-LT and CALF-20M-e, from the same metal salt and organic linker precursors but from different solvents and particularly for CALF-20M-w, different activation temperatures. NU-220 features a different topology than that of CALF-20, whereas CALF-20M-w and CALF-20M-e are isostructural to CALF-20. In all cases, the presence of methyl groups resulted in significant modifications to the pore size and pore environment. Molecular simulations suggest that the methyl groups sterically hinder the formation of hydrogen bonding networks by water molecules and further repel water molecules from approaching framework Zn—N bonds relative to the non-methylated analogues, supporting the experimentally observed increase in stability in the presence of water for these new MOFs. Humid CO₂ capture experiments confirmed that incorporating the methyl group resulted in a significant improvement in CO₂ uptake at high RH values, as CALF-20M-w-HT and CALF-20M-e maintained about 20% of their initial CO₂ uptake at 80% RH, whereas CALF-20 lost all of its initial CO₂ uptake at this same RH. As a result, CALF-20M-w and CALF-20M-e showed an ability to capture CO₂ in post-combustion flue gas environments, while NU-220 excelled among this series for CO₂ capture in dry or low RH conditions. Overall, this simple design strategy has afforded new adsorbent materials that are better suited for practical CO₂ capture conditions from humid post combustion flue gas streams than CALF-20, overcoming a significant drawback for this CO₂ adsorbent and increasing the potential success of this class of physisorbents in carbon capture technologies.

The research also investigated the fundamental mechanisms underlying the abnormal sorption behavior of CALF-20M-w at varying humidity levels, revealing how water interactions with MOF structures can significantly enhance CO₂ capture performance. Advanced characterization techniques, including in situ/ex situ single-crystal analysis and adsorption isotherms, show that CALF-20M-w undergoes reversible structural transformations across hydration phases while retaining its topological integrity. A unique negative pressure increment is observed at higher water vapor doses after equilibration, reflecting dynamic MOF-water interactions. The study highlights the critical role of the methylated triazole linker, which allows water-induced linker rotation and stabilizes the MOF structure during sorption cycles. Activation conditions are pivotal: low-temperature activation (<100° C.) yields a phase of CALF-20M-w-LT, exhibiting a Type I water isotherm and achieving a 50% increase in CO₂ uptake (from 1.8 to 2.6 mmol/g at 0.15 bar). In contrast, high-temperature activation (>120° C.) forms the phase of CALF-20M-w-HT. These findings underscore the tunable and reversible structural dynamics of CALF-20M-w, demonstrating how small linker modifications and controlled activation conditions enable unique properties, including enhanced CO₂ capture in humid environments.

The strategy demonstrated involves modifying the CALF-20 by incorporating methylated triazole linkers to enhance CO₂ selectivity in humid environments while preserving the MOF's structural integrity. By varying the mtz content, the surface chemistry and pore environment of CALF-20 are tailored to achieve improved performance. The results demonstrate that although CO₂ uptake decreases slightly with higher mtz content, the reduction is minimal at flue gas concentrations (15% CO₂), with only a 12% decrease for 4.8% mtz content. Furthermore, water uptake is significantly reduced at lower mtz levels, indicating decreased hydrophilicity and better functionality in moisture-sensitive environments. This dual-linker approach highlights CALF-20's tunable adsorption properties, making it versatile for selective gas separation and applications in humid conditions. By balancing CO₂ capacity and reduced water adsorption, this study showcases the potential of linker modifications to optimize MOFs for real-world applications like CO₂ capture from flue gases.

### Additional Information

TABLE 2
Crystal data and structure refinement for three MOFs.

| | | CALF- | CALF- | | CALF- |
|---|---|---|---|---|---|
| | NU-220 | 20M-w-LT | 20M-e | | 20M-w-HT |
| Formula | C₈H₈N₆O₄Zn₂ | C₄H₄N₃O₂Zn | C₄H₄N₃O₂Zn | | C₈H₈N₆O₄Zn₂ |
| F.W. (g mol⁻¹) | 382.94 | 191.47 | 191.47 | | 342.93 |
| Crystal system | Tetragonal | Monoclinic | Orthorhombic | | monoclinic |
| Space group | P4₃2₁2 | P2₁/c | Pbnc | | P2₁/n |
| a/Å | 14.8444(3) | 8.7479(4) | 8.5 | (3) | 10.409(2) |
| b/Å | 14.8444(3) | 8.3831(4) | 10.2 | (3) | 8.324(2) |
| c/Å | 13.2072(4) | 10.2420(4) | 16.8 | (2) | 16.946(4) |
| α/° | 90 | 90 | 90 | | 90 |
| β/° | 90 | 101.194(4) | 90 | | 98.85(2) |
| γ/° | 90 | 90 | 90 | | 90 |
| Volume/Å³ | 2910.29(12) | 736.80(6) | 1450 | (72) | 1450.8(6) |

| | | | | |
|---|---|---|---|---|
| Z | 8 | 4 | 8 | 4 |
| ρ_{calc} g/cm³ | 1.748 | 1.726 | 1.754 | 1.570 |
| μ/mm⁻¹ | 4.277 | 3.275 | 0 | 4.024 |
| F (000) | 1520 | 380 | 230 | 672.0 |
| GOF on F² | 1.065 | 1.078 | 1.185 | 3.313 |
| Final R indexes | R₁ = 0.0389, | R₁ = 0.0304, | R₁ = 0.1656, | R₁ = 0.3864, |
| [I >= 2σ (I)] | wR₂ = 0.1031 | wR₂ = 0.0835 | wR₂ = 0.4062 | wR₂ = 0.6925 |
| Final R indexes | R₁ = 0.0422, | R₁ = 0.0357, | R₁ = 0.2766, | R₁ = 0.4038, |
| [all data] | wR₂ = 0.1071 | wR₂ = 0.0859 | wR₂ = 0.4677 | wR₂ = 0.7462 |

TABLE 3
Comparison of coordination and bond lengths of
CALF-20, NU-220, CALF-20M-w-LT and CALF-20M-e.

| | | | | | CALF-20M- | CALF- | CALF- |
|---|---|---|---|---|---|---|---|
| | CALF-20 | NU-220 | | | w- LT | 20M-e | 20M-w-HT |
| Zn- | 5 | 4 | 5 | 6 | 5 | 5 | 5 |
| coordination | | | | | | | |
| Zn—O (Å) | 2.022(2), | — | 2.038(4), | 2.093(4), | 2.176(3), | 2.00(5), | 1.963, |
| | 2.189(3) | | 2.085(4) | 2.189(4) | 2.026(3) | 2.12(3) | 2.233 |
| Zn—N (1, 2) (Å) | 2.007(2), | 1.983(5), | 2.036(4), | — | 2.108(3), | 1.99(5), | 2.188, |
| | 2.091(3) | 2.022(4) | 2.122(4) | | 2.016(3) | 2.12(4) | 2.007 |
| Zn—N (4) (Å) | 2.016(3) | — | 2.034(5) | 2.090(5) | 2.037(3) | 2.05(5) | 2.092 |

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

In recognition of the inherent nature of chemical synthesis, throughout the present disclosure, terms and phrases such as “absence,” “free,” “does not comprise,” etc. encompass, but do not require a perfect absence of the referenced entity.

The term “type” as used herein refers to chemical formula such that a single type means the same chemical formula and different type means different chemical formula. Similarly, use of “more” as in “one or more” refers to use of different types of the relevant entity.

Terms such as “comprising” and the like may be replaced with terms such as “consisting” and the like.

Room temperature refers to a temperature of about 25° C.

What is claimed is:

1. A material comprising a Zn-(methyltriazolate)-(oxalate) metal-organic framework (MOF) having a chemical formula of Zn(3-methyl-1H-1,2,4-triazolate)(oxalate)_{0.5} (Zn(mtz)(ox)_{0.5}) and comprising oxalate groups forming oxalate layers and (mtz)Zn₂(mtz) groups forming (mtz)Zn₂(mtz) layers,
wherein oxalate groups of adjacent oxalate layers are parallel, wherein each methyl group of each (mtz)Zn₂(mtz) group is oriented in opposing directions, and wherein adjacent methyl groups of adjacent (mtz)Zn₂(mtz) groups and on a same side of planes defined by the oxalate groups are oriented in opposing directions; or
wherein oxalate groups of adjacent oxalate layers are non-parallel, and wherein each methyl group of each (mtz)Zn₂(mtz) group is oriented in the same direction.

2. The material of claim 1, wherein oxalate groups of adjacent oxalate layers are parallel, wherein each methyl group of each (mtz)Zn₂(mtz) group is oriented in opposing directions, and wherein adjacent methyl groups of adjacent (mtz)Zn₂(mtz) groups and on a same side of planes defined by the oxalate groups are oriented in opposing directions.

3. The material of claim 2, wherein the Zn-(methyltriazolate)-(oxalate) MOF exhibits a room temperature powder X-ray diffraction (PXRD) spectrum comprising three singlets at 10.48°, 13.22°, and 14.22°.

4. The material of claim 1, wherein oxalate groups of adjacent oxalate layers are non-parallel, and wherein each methyl group of each (mtz)Zn₂(mtz) group is oriented in the same direction.

5. The material of claim 4, wherein the Zn-(methyltriazolate)-(oxalate) MOF exhibits a room temperature PXRD spectrum comprising a doublet at 10.28° and 10.52°, another doublet at 15.02° and 15.21°, and a singlet at 13.77°.

6. The material of claim 5, wherein the Zn-(methyltriazolate)-(oxalate) MOF exhibits a kinked, S-shaped water isotherm as measured at room temperature and in dose increment mode.

7. A method for capturing CO₂, the method comprising exposing the material of claim 1 to an atmosphere comprising CO₂, wherein CO₂ is adsorbed by the Zn-(methyl triazolate)-(oxalate) MOF and removed from the atmosphere.

8. The method of claim 7, wherein the atmosphere has a relative humidity of at least 60%.

9. The method of claim 8, wherein the atmosphere is flue gas.

10. A method for synthesizing a Zn-(methyltriazolate)-(oxalate) MOF, the method comprising exposing a solution comprising zinc oxalate, 3-methyl-1H-1,2,4-triazole, and a solvent under conditions to induce crystallization of a Zn-(methyltriazolate)-(oxalate) MOF having a chemical formula of Zn(mtz)(ox)_{0.5} from the zinc oxalate and the 3-methyl-1H-1,2,4-triazole.

11. The method of claim 10, further comprising heating the Zn-(methyltriazolate)-(oxalate) MOF to an activation temperature for a period of time.

12. The method of claim 11, wherein the activation temperature is greater than 120° C.

13. The method of claim 10, wherein the solvent is selected from pure methanol, pure water, and pure ethanol.

14. The method of claim 10, wherein the solvent is pure ethanol and the Zn-(methyltriazolate)-(oxalate) MOF is CALF-20M-e.

15. The method of claim 14, wherein the CALF-20M-e MOF comprises oxalate groups forming oxalate layers and (mtz)Zn₂(mtz) groups forming (mtz)Zn₂(mtz) layers, wherein oxalate groups of adjacent oxalate layers are parallel, wherein each methyl group of each (mtz)Zn₂(mtz) group is oriented in opposing directions, and wherein adjacent methyl groups of adjacent (mtz)Zn₂(mtz) groups and on a same side of planes defined by the oxalate groups are oriented in opposing directions.

16. The method of claim 15, wherein the CALF-20M-e MOF exhibits a room temperature PXRD spectrum comprising three singlets at 10.48°, 13.22°, and 14.22°.

17. The method of claim 12, wherein the solvent is pure water the Zn-(methyl triazolate)-(oxalate) MOF is CALF-20M-w-HT.

18. The method of claim 17, wherein the CALF-20M-w-HT MOF comprises oxalate groups forming oxalate layers and (mtz)Zn₂(mtz) groups forming (mtz)Zn₂(mtz) layers, wherein oxalate groups of adjacent oxalate layers are non-parallel, and wherein each methyl group of each (mtz)Zn₂(mtz) group is oriented in the same direction.

19. The method of claim 18, wherein the CALF-20M-w-HT MOF exhibits a room temperature PXRD spectrum comprising a doublet at 10.28° and 10.52°, another doublet at 15.02° and 15.21°, and a singlet at 13.77°.

20. The method of claim 19, wherein the CALF-20M-w-HT MOF exhibits a kinked, S-shaped water isotherm as measured at room temperature and in dose increment mode.
